(19) United States
(12) Patent Application Publication
(10) Pub. No.: US 2025/0087710 A1
(43) Pub. Date: Mar. 13, 2025

(54) Arrangement, Fuel Cell Device, Flat Component and Method and Facility for Producing Same

(71) Applicants: Arno Bayer, Dettingen (DE); Saeed Eydi, Dettingen (DE); Philipp Stiefel, Dettingen (DE); Valerio Piersimoni, Dettingen (DE)

(72) Inventors: Arno Bayer, Dettingen (DE); Saeed Eydi, Dettingen (DE); Philipp Stiefel, Dettingen (DE); Valerio Piersimoni, Dettingen (DE)

(73) Assignee: EKPO Fuel Cell Technologies GmbH, Dettingen (DE)

(21) Appl. No.: 18/960,415

(22) Filed: Nov. 26, 2024

Related U.S. Application Data
(63) Continuation of application No. PCT/EP2023/064346, filed on May 30, 2023.

(30) Foreign Application Priority Data
May 31, 2022 (DE) 10 2022 113 767.8

(51) Int. Cl. H01M 8/00

(52) U.S. Cl. CPC H01M 8/006

(57) ABSTRACT

The invention relates to an arrangement, in particular an arrangement for a fuel cell device, of a plurality of flat components arranged on top of one another in an arrangement direction, wherein at least one flat component of the plurality of flat components has at least one adjustment mark, and the adjustment mark can also be detected by a detection means, in particular an optical detection means, even when at least one further flat component is arranged in the arrangement direction on top of the flat component marked with this adjustment mark.

### CROSS-REFERENCE TO RELATED PATENT APPLICATION

This application is a continuation of international application number PCT/EP2023/064346 filed on May 30, 2023, and claims the benefit of German application No. 102022113767.8 filed on May 31, 2022.

### BACKGROUND OF THE INVENTION

The invention relates to an arrangement and to a fuel cell device and to a flat member as well as to methods for producing an arrangement and a fuel cell device and a flat member as well as facilities for producing an arrangement and a fuel cell device and a flat member and uses of an arrangement and a flat member, in particular a bipolar plate, for a fuel cell device.

### SUMMARY OF THE INVENTION

The object addressed by the invention consists in improving an arrangement and a fuel cell device and a flat member as well as methods and facilities for producing an arrangement and a fuel cell device and a flat member as well as uses of an arrangement and a flat member.

In embodiments of the invention, this object is achieved by an arrangement, in particular an arrangement for a fuel cell device, of a plurality of flat components arranged on top of one another in an arrangement direction, wherein at least one flat component of the plurality of flat components, i.e., exactly one flat component or at least some flat components has/have in each case at least one adjustment mark, and the adjustment mark can be detected by a detection means, in particular an optical detection means, even when at least one further flat component is arranged in the arrangement direction on top of the flat component marked with this adjustment mark.

In embodiments of the invention, the object addressed is achieved by an arrangement, in particular an arrangement for a fuel cell device, of a plurality of flat components arranged on top of one another in an arrangement direction, wherein at least one flat component of the plurality of flat components, i.e., exactly one flat component or at least some flat components has/have in each case at least one adjustment mark and the adjustment mark is not concealed by a flat component that is the component arranged next in the arrangement direction on top of the flat component marked with this adjustment mark.

In embodiments of the invention, the object addressed is achieved in that a fuel cell device comprises at least one fuel cell unit and the at least one fuel cell unit has at least one stack (as an arrangement) of a plurality of flat members (as flat components) stacked on top of one another in a stacking direction (arrangement direction), wherein at least one flat member of the plurality of flat members, i.e., exactly one flat member or at least some flat members has/have in each case at least one adjustment mark, and the adjustment mark can be detected by a detection means, in particular an optical detection means, even when at least one further flat member is arranged in the arrangement direction on top of the flat member marked with this adjustment mark.

In embodiments of the invention, the object addressed is achieved in that a fuel cell device comprises at least one fuel cell unit and the at least one fuel cell unit has at least one stack (as an arrangement) of a plurality of flat members (as flat components) stacked on top of one another in a stacking direction (arrangement direction), wherein at least one flat member of the plurality of flat members, i.e., exactly one flat member or at least some flat members has/have in each case at least one adjustment mark and the adjustment mark is not concealed by a flat member which is the member stacked next on top of the flat member marked with this adjustment mark in the stacking direction.

In embodiments of the invention, the object addressed is achieved by a flat member which in particular comprises and/or is an arrangement, wherein the flat member comprises a plurality of flat products (as flat components) and the flat products at least co-form the flat member, wherein at least one flat product of the plurality of flat products, i.e., exactly one flat product or at least some flat products has/have in each case at least one adjustment mark, and the adjustment mark can be detected by a detection means, in particular an optical detection means, even when at least one further flat product is arranged in the vertical direction (arrangement direction) on top of the flat product marked with this adjustment mark.

In embodiments of the invention, the object addressed is achieved by a flat member which in particular comprises and/or is an arrangement, wherein the flat member comprises a plurality of flat products (as flat components) and the flat products at least co-form the flat member, wherein at least one flat product of the plurality of flat products, i.e., exactly one flat product or at least some flat products has/have in each case at least one adjustment mark, and the adjustment mark is not concealed by a flat product which is the next product arranged on top of the flat product marked with this adjustment mark in a vertical direction (arrangement direction).

One advantage of the solution according to the invention may in particular be considered in that, due to the at least one adjustment mark of a flat component, which is also identifiable when a flat component is arranged directly above it, a position and/or orientation of the flat component marked with the at least one adjustment mark can still be identified even after the arrangement of the flat component stacked above it, and thus at least one further flat component can be arranged on top of the flat components already stacked on top of one another so as to be correctly positioned relative to the marked flat component.

Advantageously, the solution according to the invention can be used to react to any shifting of at least one flat component marked with at least one adjustment mark when arranging the plurality of flat components on top of one another to form the stack, wherein, for example, shifting can occur when arranging the flat component arranged directly above it. In particular, a further flat component can be suitably arranged relative to the shifted position of the marked flat component and/or the position of the shifted marked flat component may be corrected.

In particular, positioning accuracy of at least some flat components designed as flat members, preferably at least most of the flat members, for example at least most of the bipolar plates, of the plurality of flat components designed as flat members in the stack can be increased, preferably over the entire stack height of the stack.

In particular, a flat member made from flat products in the form of flat components can be produced more precisely.

Since in particular a tolerance chain along the flat components stacked on top of one another can be improved, the individual flat members for the stack, in particular functional regions in the flat components, for example fluid-carrying structures therein, can advantageously be designed with lower tolerance, i.e., more precisely.

In particular, the solution according to the invention is advantageous if at least two flat components that are not arranged directly on top of one another, in particular flat products in a flat member and/or flat members in a stack, are to be aligned with great precision relative to one another, since they have, for example, corresponding structures that must be precisely aligned with respect to one another.

In particular, it is advantageous if at least one flat member in the stack designed as a bipolar plate is provided with at least one such adjustment mark, since typically a further flat member, in particular designed as a membrane member, is arranged on a bipolar plate and a further bipolar plate is arranged above it and these two bipolar plates collectively at least form a cell unit of the fuel cell unit, for example, and form in each case fluid-carrying structures which must be arranged precisely on top of one another in the stacking direction, with the at least one further flat member therebetween, for precisely carrying a fluid and for sealing individual portions of the fluid-carrying structures and/or for supporting one another.

Preferably, at least one flat component, i.e., exactly one flat component or at least some flat components in each case, has at least one adjustment mark, i.e., exactly one adjustment mark or a plurality of adjustment marks. In some advantageous embodiments, at least some adjustment marks have some identical features, and/or in some advantageous embodiments, at least some adjustment marks have at least one different feature. For the sake of easier readability, reference is made below only to “the/one/at least one adjustment mark” and/or “the/one/at least one flat component provided with at least one adjustment mark,” and it is to be understood within these and similar formulations that the correspondingly explained feature is implemented in above-discussed variations of advantageous embodiments.

No further details have yet been provided regarding the design of the at least one adjustment mark.

In advantageous embodiments, it is provided that at least one adjustment mark of at least one flat component is designed not to interact with at least one other, in particular with at least the next, flat component.

In particular, one advantage of this is that a flat component provided with an interaction-free adjustment mark does not interact with the flat component arranged next thereon and in particular with the flat component arranged thereunder because of the adjustment mark and thus the adjustment of the flat component is at least less impaired by the adjacent flat components, and/or during the adjustment, the flat components already arranged are at least less impaired, in particular in terms of their position and/or orientation.

It is particularly advantageous if at least one adjustment mark of at least one flat component does not at least substantially increase and/or at least substantially reduce a thickness of the flat component and is thus preferably designed to be at least substantially thickness-neutral.

This is advantageous in particular because, as a result of the flat component having a thickness that does not at least substantially increase, the at least one adjustment mark does not come into contact with and interact with an adjacent flat component, and therefore the adjustment of the flat components independently of one another is at least not impaired by the adjustment mark.

In particular, a flat component extends at least substantially in a geometric surface plane (in particular a areal extension plane), which is spanned by two surface directions (in particular by areal extension directions and/or averaged directions of extension), and an extension of the flat component in a direction that is at least approximately perpendicular to the geometric surface plane (in particular a vertical direction) is significantly smaller, in particular at least ten times smaller, for example at least fifty times smaller, than an extension of the flat component in the geometric surface plane.

It is particularly advantageous if, in the direction perpendicular to the surface plane (vertical direction) of the flat component, at least one other portion of the flat component protrudes further than the at least one adjustment mark. Advantageously, the flat component provided with the adjustment mark thus interacts with a flat component arranged next to it via the at least one other portion, for example the two flat components rest on one another at this at least one other portion, and their interaction is not dependent on the design of the adjustment mark.

It is particularly advantageous if at least one adjustment mark of at least one flat component is optically detectable and in particular is optically high-contrast.

In particular, this allows the adjustment mark to be effectively and easily detected by an optical detection means and is particularly precise and/or easy to detect even in the event of minor disturbances, such as contamination and/or impaired lighting conditions.

In particular, an adjustment mark can be optically detected if it has a structure that can be distinguished in the spectral range of visible light.

In particular, an adjustment mark is designed to be optically high-contrast if it has sufficiently sharp transitions between different mark regions in relation to the spectral range of visible light, wherein the different mark regions are identifiable at sufficiently different wavelengths of visible light.

It is particularly advantageous if at least one adjustment mark of at least one flat component is formed on a portion of the flat component which is continuously formed with material.

In particular, the portion with the adjustment mark is thus devoid of material-free gaps.

In particular, one advantage of this is that the portion formed continuously with material forms a well-defined background for the adjustment mark and the mark region of the adjustment mark itself is also formed continuously with material and thus the well-defined adjustment mark is formed on a well-defined background and can thus be detected more smoothly and precisely by a detection means.

It is particularly advantageous if at least one adjustment mark of at least one flat component, in particular of a flat product and/or a flat member, is formed on an outer side of the marked flat component, which faces the flat component arranged/stacked next in the arrangement direction (in particular a stacking direction and/or a vertical direction).

In particular, at least one adjustment mark of at least one flat component is formed on a surface portion of the marked flat component facing the flat component arranged/stacked next in the arrangement direction (in particular a stacking direction and/or a vertical direction).

This advantageously makes it possible for the at least one adjustment mark to be identifiable on the side on which the further flat components are arranged when the further flat components are arranged on top of one another.

In particular, it is provided that the flat component stacked next on top of the marked flat component in the arrangement direction (in particular a stacking direction and/or a vertical direction) rests on at least partial regions of the outer side of the marked flat component facing this flat component stacked next.

Advantageously, at least one adjustment mark of at least one flat component is formed only on a surface region, preferably on the outer side of the flat component marked therewith facing the flat component arranged next, in particular stacked.

In particular, an adjustment mark is formed at least substantially only on a surface region if the adjustment mark is produced by a surface technology, advantageously physically and/or chemically and/or mechanically, and/or if the adjustment mark is formed by a structure formed on the surface and/or formed at the surface and/or penetrating into the material of the flat component close to the surface at the very most.

In particularly advantageous embodiments, at least one adjustment mark of at least one flat component is a pattern welded into the at least one flat component.

In particular, a pattern of the adjustment mark can thus advantageously only be realized in a simple and high-contrast manner in one surface region.

In particular, at least one adjustment mark created by welding is a welding pattern without a joint connection.

Thus, in particular, the welding pattern is only intended to form the adjustment mark, but not join parts of the flat component, and therefore the welding pattern can be specifically optimized in terms of its position and/or design for its function as an adjustment mark.

In some advantageous embodiments, at least one adjustment mark is formed as at least one depression, in particular as an aperture, in at least one flat component.

Advantageously, the adjustment mark has a precise design.

Advantageously, at least one adjustment mark, in particular at least some adjustment marks, is/are formed with an offset of less than 0.2 mm, preferably less than 0.1 mm, in particular less than 0.05 mm.

Preferably, at least one adjustment mark, in particular at least some adjustment marks, is/are formed with high repeatability, wherein any inaccuracy in a repeated formation of adjustment marks is at most 0.1 mm, preferably at most 0.05 mm, in particular at most 0.02 mm.

For example, such precise adjustment marks are achieved by welding.

In particular, at least one adjustment mark comprises a line pattern consisting of a plurality of lines, in particular straight lines, for example comprising parallel lines and/or intersecting lines and/or lines arranged at an angle to one another. For example, at least some of the lines form a cross and/or a coordinate system.

For example, at least one adjustment mark comprises elliptical or circular mark parts.

In particular, at least some lines and/or elliptical and/or circular mark parts can be advantageously formed by means of weld seams.

It is particularly advantageous if at least one adjustment mark can be used to detect the orientation of the flat component provided therewith.

In some advantageous embodiments, at least one adjustment mark of at least one flat component is designed to be rotationally asymmetrical in such a way that the orientation of the marked flat component, in particular the alignment of the marked flat component in the geometric surface plane of the flat component, can be detected using this rotationally asymmetric adjustment mark.

In particular, in advantageous embodiments, it is provided that the orientation of at least one flat component, in particular the orientation of the flat component in its geometric surface plane, can be detected by this flat component having at least two adjustment marks, which are in particular distinguishable from one another.

In embodiments of the invention, the object addressed is alternatively or additionally achieved in that a geometric connecting line, which connects two adjustment marks of a flat component, runs through the surface center of mass of the flat component.

Preferably, the surface center of mass of the flat component is at least substantially equidistant from the two adjustment marks connected by the geometric connecting line.

Advantageously, by detecting the at least two adjustment marks, the position of the surface center of mass can thus also be detected, at least on the connecting line and advantageously midway between the two adjustment marks.

The object addressed by the invention is thus achieved by an arrangement, in particular an arrangement for a fuel cell device, of a plurality of flat components arranged on top of one another in an arrangement direction, wherein at least one flat component of the plurality of flat components, i.e., exactly one flat component or at least some flat components has/have in each case at least two adjustment marks and wherein a geometric connecting line which connects the two adjustment marks runs through the surface center of mass of the flat component.

In embodiments of the invention, the object addressed is thus achieved in that a fuel cell device comprises at least one fuel cell unit and the at least one fuel cell unit has at least one stack (as an arrangement) of a plurality of flat members (as flat components) stacked on top of one another in a stacking direction (arrangement direction), wherein at least one flat member of the plurality of flat members, i.e., exactly one flat member or at least some flat members has/have in each case at least two adjustment marks and in that a geometric connecting line which connects the two adjustment marks runs through the surface center of mass of the flat member.

In embodiments of the invention, the object addressed is thus achieved by a flat member which in particular comprises and/or is an arrangement, wherein the flat member comprises a plurality of flat products (as flat components) and the flat products at least co-form the flat member, wherein at least one flat product of the plurality of flat products, i.e., exactly one flat product or at least some flat products has/have in each case at least two adjustment marks and in that a geometric connecting line which connects the two adjustment marks runs through the surface center of mass of the flat product.

Advantageously, in these embodiments, at least one, and/or at least a combination, of the features explained above and/or below, in particular optional features, are formed.

In some advantageous embodiments, at least one adjustment mark, in particular at least one of the at least two adjustment marks, has at least one feature, and/or at least a combination of features, which is described in connection with an alignment structure.

Preferably, the at least two adjustment marks are adjustment marks that are optically in particular easy to detect.

In some advantageous embodiments, at least one of the at least two adjustment marks can be detected by a detection means, in particular an optical detection means, even when at least one further flat component is arranged in the arrangement direction on top of this flat component marked with at least two adjustment marks and/or at least one of the at least two adjustment marks is not concealed by a flat component which is the component arranged next in the arrangement direction on top of the flat component marked with these at least two adjustment marks.

In some advantageous embodiments, at least one of the at least two adjustment marks can no longer be detected by a detection means, in particular an optical detection means, when at least one further flat component is arranged on top of this flat component marked with at least two adjustment marks and/or at least one of the at least two adjustment marks is concealed by the flat component arranged next.

In such embodiments, the at least two adjustment marks are advantageously detected before the flat component is arranged next and their position and in particular thus also the position of the surface center of mass of the flat component and, for example, the alignment of the flat component are stored. The stored positions are then used to adjust and advantageously precisely arrange the flat components to be arranged next.

In particular, each flat component extends in its geometric areal extension plane up to an edge.

In particular, at least one flat component, and advantageously at least some flat components, has/have in each case an edge region which is located, in particular with respect to the extension of the flat component in its geometric areal extension plane, at the edge of the extension.

For example, at least one flat component, in particular at least most of the flat components has/have in each case, in their extension in the geometric surface plane, one or more openings in their edge region for further components of the fuel cell device, for example a distributor structure for fluids, in particular for an oxidation medium and/or a fuel medium and/or a product medium.

In particular, at least one flat component, preferably at least some, in particular at least most, of the plurality of flat components has/have in each case a functional region.

In the case of a flat component, the functional region thereof is advantageously circumferentially surrounded by the edge region.

Preferably, at least one adjustment mark of at least one flat component is arranged in an edge region of the marked flat component.

Advantageously, at least one adjustment mark of at least one flat component is arranged adjacently to the edge of the marked flat component.

Advantageously, it is provided that at least one adjustment mark of at least one flat component is formed in a predefined positioning region.

Advantageously, this makes it possible not only to identify the adjustment mark, but also to identify whether it is formed in the predefined positioning region such that control of the proper formation of the flat component is possible, at least to some extent.

Preferably, the predefined positioning region is located in the edge region of the flat component and advantageously adjacently to the edge of the flat component.

It is particularly advantageous if the predefined positioning region can be detected by a detection means, in particular an optical one.

For example, the detectable predefined positioning region has a detectable structure, for example an advantageously specially designed detectable edge contour of the edge, by means of which the detection means can detect the detectable positioning region.

No further details have been given thus far for the further design of the flat components, in particular the design of the flat component arranged next to a marked flat component.

In advantageous embodiments, it is provided that the flat component arranged next, in particular stacked, in the stacking direction on top of the at least one flat component marked with at least one adjustment mark is free of material in the region of the at least one adjustment mark of the marked flat component and is in particular free of material in a region of the associated predefined positioning region.

In particular, this advantageously makes it possible to detect and in particular see the adjustment mark of the underlying marked flat component and advantageously does not conceal it.

In particular, the region of the adjustment mark and/or the positioning region of the flat component arranged next is to be understood as a region of a projection of the adjustment mark and/or the positioning region of the marked flat component onto the flat component arranged next, in particular a projection in the arrangement direction and/or, for example, a projection onto the geometric surface plane of the flat component arranged next.

Advantageously, it is provided that the flat component that is the component stacked next in the arrangement direction on top of the at least one flat component marked with at least one adjustment mark has a recess in the region of the at least one adjustment mark.

For example, the recess is provided within an extension of the flat component, in particular within the extension in its geometric areal extension plane.

In particularly advantageous embodiments, it is provided that in the flat component which is the component arranged next in the arrangement direction on top of the at least one flat component marked with at least one adjustment mark, a region of at least one adjustment mark and, for example, the associated positioning region of the at least one marked flat component lies outside an extension of the flat component arranged next, in particular outside its extension in its geometric areal extension plane.

In some preferred embodiments, at least one flat component marked at least with an adjustment mark has a protruding portion comprising the at least one adjustment mark, wherein in particular the predefined and advantageously detectable positioning region is at least located in the protruding portion and/or is formed by this portion.

For example, the protruding portion projects beyond an edge contour averaged over the arrangement, in particular an edge contour averaged over the stack and/or an edge contour of the flat member.

In some preferred embodiments, the flat component that is the component arranged next on at least one flat component marked with at least one adjustment mark has a set-back edge in the region of at least one adjustment mark of the marked flat component, wherein in particular the edge is set back with respect to an edge contour of the marked flat component and/or with respect to an edge contour averaged over the arrangement.

In particular, the flat component stacked next thus has a recess in its edge or edge region, whereby the adjustment mark and, for example, the associated predefined positioning region of the underlying marked flat component can advantageously be detected and/or is not concealed.

In particular, at least some of the plurality of flat components have different thicknesses, in particular in their respective functional regions and/or, for example, along their respective extensions in their respective geometric surface planes, wherein the thickness is measured in the corresponding direction (arrangement direction, stacking direction, vertical direction).

In particular, at least some of the plurality of flat components have structures in their functional region which cause different thicknesses of the flat components and/or fluid-carrying structures for a fluid, in particular for an oxidation medium and/or a fuel medium and/or a product medium and/or a temperature-control medium.

In particular, at least two flat members of the stack designed as flat components, which form in each case a bipolar plate in particular, at least co-form a cell unit of the fuel cell unit, wherein at least one further flat member, which is designed in particular as a membrane member, is arranged in particular between these two flat members.

In particularly advantageous embodiments, it is provided that at least some of the plurality of flat components, each of which comprises a functional region having different thicknesses, are each provided with at least one adjustment mark.

This is in particular advantageous because these flat components with functional regions having different thicknesses are at least typically to be precisely adjusted relative to one another, for example so that corresponding portions of the different flat components can support one another, and this precise alignment is improved by the adjustment mark.

In particular, it is provided that at least some of the flat components, which have fluid-carrying structures in their functional region, are each provided with at least one adjustment mark.

This advantageously ensures that at least one further flat component can be precisely aligned and arranged on top of at least some flat components having fluid-carrying structures, even if a flat component has been arranged therebetween, and thus, for example, fluid-carrying structures that correspond to one another are more precisely aligned with one another and/or portions that are to be sealed with respect to one another lie more precisely against one another so as to improve carrying and distribution of the at least one fluid, and, for example, the fluid-carrying structures can be designed with smaller tolerances.

In particular, the at least one fuel cell unit has a plurality of cell units, wherein electrical energy is provided in each cell unit by chemical conversion of a fuel medium and an oxidation medium into a product medium, and in particular each of the cell units comprises fluid-carrying structures for the oxidation medium and/or the fuel medium and/or the product medium and/or a temperature-control medium.

In particular, the plurality of cell units in the stack are connected in series.

In particular, it is provided that at least two flat members, which form in each case in particular in an electrode of a cell unit, at least co-form a cell unit.

Advantageously, it is provided that in at least some of the plurality of cell units of the at least one fuel cell unit, at least one of the flat components co-forming the cell unit, for example at least one of the flat components forming an electrode, has at least one adjustment mark.

In particular, this advantageously ensures that at least one further flat component co-forming the cell unit can be precisely adjusted with the flat component having the adjustment mark and thus the cell unit is precisely formed.

In particular, it is provided that at least some, in particular at least most, of the flat members in the at least one stack which are designed as a bipolar plate have at least one adjustment mark.

This is in particular advantageous because precise alignment of the bipolar plates relative to one another is particularly important.

In particular, it is provided that at least most of the cell units each comprise at least one flat member, for example designed as a membrane member, which is in particular the member stacked next on a flat member marked with at least one adjustment mark.

In particular, a further flat component, for example a membrane member in the case of flat members, is arranged between each two flat components having fluid-carrying structures and/or forming an electrode, which in particular collectively at least co-form a cell unit.

In particular, it is provided that in at least some, preferably in at least most, of the flat members designed as a bipolar plate, a flat member designed in particular as a membrane member is arranged next and in particular this flat member arranged next is free of material in the region of at least one adjustment mark of the flat member designed as a bipolar plate.

This is particularly advantageous since the flat members arranged above and below the flat member designed in particular as a membrane member must be precisely aligned with one another.

In embodiments of the invention, the object addressed that is mentioned at the outset is achieved by a method for producing an arrangement and/or a fuel cell device and/or a flat member.

In embodiments of the invention, the method comprises at least the following steps of:
providing a plurality of flat components, providing at least one flat component with at least one adjustment mark, arranging at least one further flat component in an arrangement direction (in particular a stacking direction and/or a vertical direction) on top of the flat component provided with at least one adjustment mark, wherein even after the arrangement of the at least one further flat component the at least one adjustment mark of the at least one flat component provided therewith can be detected by a detection means, in particular an optical detection means, and/or wherein the at least one adjustment mark of the at least one flat component provided therewith is not concealed by the at least one further flat component, wherein therefore in particular even after the arrangement of the at least one further flat component the at least one adjustment mark is not concealed by the at least one further flat component.

In particular, an advantage of the method according to the invention is that, based on the at least one detectable and/or non-concealed adjustment mark, the alignment, in particular position and/or orientation, of the flat component provided with the at least one adjustment mark can be recognized even after the arrangement of the at least one further flat component and, for example, a shifting of the at least one marked flat component can be responded to and/or in particular that at least another further flat component can be adjusted relative to the flat component provided with at least this one adjustment mark using this recognizable adjustment mark and can thereby advantageously be arranged precisely relative to the flat component provided with the at least one adjustment mark, even though at least one further flat component is arranged in between.

The at least one adjustment mark can be detected and/or is advantageously not concealed by a corresponding arrangement of the further flat component, in particular relative to the flat component provided with the at least one adjustment mark and/or by a corresponding design of the further flat component and/or the at least one adjustment mark on the flat component provided with it.

In advantageous embodiments of the method according to the invention for producing an arrangement and/or a fuel cell device and/or a flat member, in particular of the type explained above, the method comprises at least one step or several steps for forming an arrangement and/or a fuel cell device and/or a flat member with at least one, and/or at least a combination, of the in particular optional features that were explained above and/or below, so that reference is made in full to the relevant explanations.

It is particularly advantageous if at least one adjustment mark of at least one flat component is formed by welding, preferably by laser welding.

In particular, at least one flat component is formed from a plurality of elements.

For example, at least some of the plurality of elements forming a flat member are flat products.

In particular, at least some of the plurality of elements forming the at least one flat component are joined, in particular welded together.

In particularly advantageous embodiments, it is provided that the same tool is used to weld at least some of the plurality of elements forming the at least one flat component, in particular at least some flat products, to one another and to provide the at least one flat component, for example at least one of its plurality of elements, with at least one adjustment mark, in particular by welding.

In particular, one advantage of joining at least some elements and providing them with at least one adjustment mark in the same tool may be considered in that this improves the provision of the adjustment mark in the correct position relative to the joining points, for example it is more reproducible and/or more precise, and/or the at least some elements only need to be precisely aligned and arranged once with respect to one another in order to join them together and to provide them with at least one adjustment mark, and/or the risk of misalignment, which exists when changing the tool used for joining them on the one hand and for providing them with at least one adjustment mark on the other, is at least reduced.

Advantageously, when joining at least some elements and providing them with at least one adjustment mark in the same tool, the tolerance can be improved, for example because additional tolerance for another tool in the tolerance chain is no longer required.

In some particularly advantageous embodiments, it is provided that welding at least some elements, in particular at least some flat products, and providing them with at least one adjustment mark is carried out by means of the same welding device.

Advantageously, it is provided to arrange at least another further flat component on top of the further flat component.

Alternatively or additionally, in embodiments of the invention, the method comprises the steps of adjusting at least one further flat component relative to the at least one flat component provided with at least one adjustment mark by means of at least one detectable and/or non-concealed adjustment mark of the marked flat component, which was provided with the at least one adjustment mark, for example, in a previous step, and arranging the at least one further flat component, in particular in the adjusted position, in particular in the arrangement direction (in particular a stacking direction and/or a vertical direction), on flat components already arranged on top of one another, for example to form part of a stack of arranged flat members, which in particular comprise the at least one flat component marked with at least one adjustment mark and in particular at least one further flat component, wherein the at least one further flat component is the component arranged next, in particular in the arrangement direction (in particular a stacking direction and/or a vertical direction), on top of the at least one flat component marked with at least one adjustment mark, wherein in particular the at least one further flat component was arranged directly on top of at least one marked flat component in a previous step as the flat component stacked next, in particular with respect to the arrangement direction (in particular a stacking direction and/or a vertical direction).

In some preferred embodiments, it is provided that the at least one further flat component, which is adjusted by means of at least one adjustment mark of a flat component, is adjusted in such a way that a functional region of the at least one further flat component to be adjusted is adjusted relative to a functional region of the flat component provided with at least one adjustment mark, in particular is adjusted in such a way that at least corresponding partial regions of the functional regions are preferably precisely adjusted with one another.

In particular, the functional regions have protruding portions, in particular as explained above, and/or, for example, portions of fluid-carrying structures, in particular in a direction (in particular the arrangement direction and/or vertical direction and/or stacking direction) of the flat components to be adjusted relative to one another.

In particularly advantageous embodiments, it is provided that when adjusting the functional regions, corresponding, for example protruding, portions, for example corresponding portions of fluid-carrying structures, are adjusted relative to one another in each of the functional regions.

This is particularly advantageous because the corresponding portions, which for example are to be arranged so as to support one another and/or have to be arranged in a coordinated manner in order to carry fluids, are thus precisely aligned relative to one another, wherein in particular at least one portion of the further flat component arranged therebetween is arranged between the corresponding portions.

Preferably, it is provided that in order to adjust at least one further flat component to be arranged in the stacking direction, at least one adjustment mark of at least one already arranged flat component is detected by at least one preferably optical detection means.

For example, the at least one preferably optical detection means is a camera.

Advantageously, in order to ensure good detectability of the at least one adjustment mark, it is designed in particular as an optically high-contrast adjustment mark, advantageously as explained above and/or below.

In advantageous embodiments, it is provided that at least one adjustment mark is formed in a predefined positioning region of the flat component to be provided with the at least one adjustment mark.

In particular, the positioning region and the at least one adjustment mark in the positioning region are designed and/or arranged as explained above and/or below such that reference is made to these statements in full.

It is particularly advantageous if at least one detection means, in particular an optical one, in particular the detection means which also detects the at least one adjustment mark, detects the positioning region.

It is particularly advantageous if the method comprises the step of checking, at least for a flat component in which at least one adjustment mark is detected, in particular optically, whether this at least one adjustment mark is formed in a positioning region provided for this at least one adjustment mark and is in particular predefined so as to be accurately positioned within predetermined tolerance limits.

Thus, at least one step is carried out which checks whether the at least one adjustment mark has been correctly provided, and, for example, this check can also be used to advantageously conclude that further features have been correctly formed, for example if at least some elements of the flat component are joined in the same tool used for providing them with the at least one adjustment mark.

In embodiments of the invention, the object mentioned at the outset is also achieved by a facility for producing an arrangement and/or a fuel cell device and/or a flat member, wherein the arrangement and/or the fuel cell device and/or the flat member has a plurality of flat components arranged on top of one another in an arrangement direction.

In advantageous embodiments of a facility according to the invention, this facility is designed to form an arrangement and/or a fuel cell device and/or a flat member with at least one, and/or at least a combination, of the optional features explained above and/or below, for example, and in particular the facility has at least one tool required for this purpose and/or at least one device required for this purpose.

In particularly advantageous embodiments of the facility according to the invention, this facility is designed to carry out a method having a feature or at least a combination of the optional features explained above and/or below in connection with a method according to the invention, for example, and in particular the facility has at least one tool and/or at least one device required for this purpose.

In particularly preferred embodiments of a facility according to the invention, the facility comprises at least one tool for providing at least one flat component with at least one adjustment mark and at least one adjustment device, wherein the adjustment device is designed to adjust at least one further flat component relative to the flat component provided with the at least one adjustment mark, on which component at least one further flat component is already arranged, by means of the at least one adjustment mark.

In particular, one advantage of this facility can be considered in that the adjustment device can be used to arrange, preferably precisely, the at least one further flat component relative to the flat component provided with at least one adjustment mark, although at least one further flat component is already arranged on top of this flat component provided with at least one adjustment mark.

It is particularly advantageous if the adjustment device comprises at least one detection means, preferably at least one optical detection means, for detecting the at least one adjustment mark of the at least one flat component.

For example, the at least one optical detection means is a camera.

In particularly preferred embodiments of the facility, at least one tool of the facility is designed to provide at least one flat component with an adjustment mark and to join at least some elements that at least co-form the flat component.

In advantageous embodiments, the tool for providing the flat component with at least one adjustment mark comprises at least one welding device.

In particularly advantageous embodiments, it is provided that the facility comprises at least one welding device for providing the flat component with the at least one adjustment mark and for joining at least some elements of the flat component.

In embodiments, the object addressed by the invention is achieved by using a flat component, in particular a flat product and/or a flat member, for example a bipolar plate.

In embodiments of a use according to the invention, the flat component is used for a fuel cell device which has one or at least some of the optional features explained, for example, above and/or below in connection with a fuel cell device.

In some advantageous embodiments of a use of a flat component according to the invention, this is used for a method which has one or at least some of the optional features explained, for example, above and/or below in connection with a method.

In advantageous embodiments of a use according to the invention, the flat component is used in a facility for producing an arrangement and/or a fuel cell device and/or a flat member, which has one or at least some of the features explained above and/or below in connection with a facility, in particular for producing a corresponding arrangement and/or fuel cell device and/or flat member.

In particular, in advantageous uses it is provided that at least one flat component is provided with at least one adjustment mark, preferably as explained above and/or below.

In preferred uses, it is provided that at least one flat component is used to be arranged on an already arranged flat component provided with at least one adjustment mark, wherein, in particular due to the design and/or arrangement of the at least one flat component, at least one adjustment mark of the already arranged flat component can still be detected and/or is not concealed even after the arrangement of the at least one flat component used.

In some advantageous uses, at least one flat component is used to adjust it relative to a flat component provided with at least one adjustment mark, on which at least one further flat component is already arranged, and to arrange it on top of the already arranged flat components in a manner in which it is adjusted.

Above and below, features which are described as being provided in particular and/or expediently and/or by way of example and/or preferably and/or advantageously and/or the like are optional features which, for example, form developments of the invention but are not absolutely necessary for the basic inventive concept.

The description of solutions according to the invention comprises in particular the various feature combinations defined by the following numbered embodiments:
1. An arrangement of a plurality of flat components (125, 143, 144, 262) arranged on top of one another in an arrangement direction (129, 158) for a fuel cell device (100), wherein at least one flat component (125, 143, 144, 262) of the plurality of flat components (125, 143, 144, 262) has at least one adjustment mark (212), and the adjustment mark (212) can be detected by a detection means (222), in particular an optical detection means, even when at least one further flat component (125, 143, 144, 262) is arranged in the arrangement direction (129, 158) on top of the flat component (125, 143, 144, 262) marked with this adjustment mark (212).
2. The arrangement of a plurality of flat components (125, 143, 144, 262) arranged on top of one another in an arrangement direction (129, 158) for a fuel cell device (100), in particular according to embodiment 1, wherein at least one flat component (125, 143, 144, 262) of the plurality of flat components (125, 143, 144, 262) has at least one adjustment mark (212), and the adjustment mark (212) is not concealed by a flat component (125, 143, 144, 262) which is the component arranged next in the arrangement direction (129, 158) on top of the flat component (125, 143, 144, 262) marked with this adjustment mark (212).
3. A fuel cell device (100) having an arrangement according to any one of the preceding embodiments, wherein at least some flat components (125, 143, 144, 262) are flat members (125, 143, 144) and the arrangement is a stack (127) of a plurality of flat members (125, 143, 144) of a fuel cell unit (110) stacked on top of one another in a stacking direction (129).
4. The flat member (125, 143, 144) comprising an arrangement according to either embodiment 1 or embodiment 2, wherein at least some flat components (125, 143, 144, 262) are flat products (262) which at least co-form the flat member (125, 143, 144).
5. The arrangement and/or fuel cell device (100) and/or flat member (125, 143, 144) according to any one of the preceding embodiments, wherein at least one adjustment mark (212) of at least one flat component (125, 143, 144, 262) is designed not to interact with at least the flat component (125, 143, 144, 262) arranged next.
6. The arrangement and/or fuel cell device (100) and/or flat member (125, 143, 144) according to any one of the preceding embodiments, wherein at least one adjustment mark (212) of at least one flat component (125, 143, 144, 262) at least does not substantially increase and/or at least substantially reduce a thickness of the flat component (125, 143, 144, 262).
7. The arrangement and/or fuel cell device (100) and/or flat member (125, 143, 144) according to any one of the preceding embodiments, wherein at least one adjustment mark (212) of at least one flat component (125, 143, 144, 262) is optically detectable and in particular is optically high-contrast.
8. The arrangement and/or fuel cell device (100) and/or flat member (125, 143, 144) according to any one of the preceding embodiments, wherein at least one adjustment mark (212) of at least one flat component (125, 143, 144, 262) is formed on a portion of the flat component (125, 143, 144, 262) which is continuously formed with material.
9. The arrangement and/or fuel cell device (100) and/or flat member (125, 143, 144) according to any one of the preceding embodiments, wherein at least one adjustment mark (212) of at least one flat component (125, 143, 144, 262) is formed on a surface portion (232) of the marked flat component (125, 143, 144, 262) which faces the flat component (125, 143, 144, 262) arranged next in the arrangement direction (129, 158).
10. The arrangement and/or fuel cell device (100) and/or flat member (125, 143, 144) according to any one of the preceding embodiments, wherein at least one adjustment mark (212) of at least one flat component (125, 143, 144, 262) is formed only on a surface region of the flat component (125, 143, 144, 262) marked therewith.
11. The arrangement and/or fuel cell device (100) and/or flat member (125, 143, 144) according to any one of the preceding embodiments, wherein at least one adjustment mark (212) of at least one flat component (125, 143, 144, 262) is a pattern that is welded into the at least one flat component (125, 143, 144, 262).
12. The arrangement and/or fuel cell device (100) and/or flat member (125, 143, 144) according to any one of the preceding embodiments, wherein at least one adjustment mark (212) formed by welding is a welding pattern without a joint connection.
13. The arrangement and/or fuel cell device (100) and/or flat member (125, 143, 144) according to any one of the preceding embodiments, wherein at least one adjustment mark (212) is designed as at least one depression, in particular as an aperture, in at least one flat component (125, 143, 144, 262).
14. The arrangement and/or fuel cell device (100) and/or flat member (125, 143, 144) according to any one of the preceding embodiments, wherein at least one adjustment mark (212) of at least one flat component (125, 143, 144, 262) is designed to be rotationally asymmetrical such that the orientation of the marked flat component (125, 143, 144, 262) can be detected using this rotationally asymmetric adjustment mark (212).
15. The arrangement and/or fuel cell device (100) and/or flat member (125, 143, 144) comprising a plurality of flat components (125, 143, 144, 262), in particular according to any one of the preceding embodiments, wherein at least one flat component (125, 143, 144, 262) has at least two adjustment marks (212) and wherein a geometric connecting line (226) which connects the two adjustment marks (212) runs through the surface center of mass (228, 308) of the flat component (125, 143, 144, 262).
16. The arrangement and/or fuel cell device (100) and/or flat member (125, 143, 144) comprising a plurality of flat components (125, 143, 144, 262), in particular according to any one of the preceding embodiments, wherein the surface center of mass (228, 308) of the flat component (125, 143, 144, 262) is at least substantially equally spaced from at least two adjustment marks (212).
17. The arrangement and/or fuel cell device (100) and/or flat member (125, 143, 144) according to any one of the preceding embodiments, wherein at least one adjustment mark (212) of at least one flat component (125, 143, 144, 262) is formed in a predefined positioning region (216) which can be detected in particular by a detection means, in particular an optical detection means.
18. The arrangement and/or fuel cell device (100) and/or flat member (125, 143, 144) according to any one of the preceding embodiments, wherein the flat component (125, 143, 144, 262) arranged next in the stacking direction (129) on top of the at least one flat component (125, 143, 144, 262) marked with at least one adjustment mark (212) is free of material in the region of the at least one adjustment mark (212) of the marked flat component (125, 143, 144, 262).
19. The arrangement and/or fuel cell device (100) and/or flat member (125, 143, 144) according to any one of the preceding embodiments, wherein, in the case of the flat component (125, 143, 144, 262) which is the component arranged next in the stacking direction (129) on top of the at least one flat component (125, 143, 144, 262) marked with at least one adjustment mark (212), a region of at least one adjustment mark (212) of the at least one marked flat component (125, 143, 144, 262) lies outside an extension of the flat component (125, 143, 144, 262) arranged next.
20. The arrangement and/or fuel cell device (100) and/or flat member (125, 143, 144) according to any one of the preceding embodiments, wherein at least some of the plurality of flat components (125, 143, 144, 262) each comprise a functional region (172) having different thicknesses and/or fluid-carrying structures and are each provided with at least one adjustment mark (212).
21. The arrangement and/or fuel cell device (100) according to any one of the preceding embodiments, wherein at least two flat members (125, 143, 144) at least co-form a cell unit (124) of the at least one fuel cell unit (110) in each case and, for at least some cell units (124), at least one of the flat members (125, 143, 144) co-forming the cell unit (124) in each case has at least one adjustment mark (212).
22. The arrangement and/or fuel cell device (100) according to any one of the preceding embodiments, wherein at least some, in particular at least most, of the flat members (125, 143, 144) in the at least one stack (127) which are designed as a bipolar plate (143) have at least one adjustment mark (212).
23. The arrangement and/or fuel cell device (100) and/or flat member (125, 143, 144), in particular according to any one of the preceding embodiments, wherein the arrangement and/or the fuel cell device (100) and/or the flat member (125, 143, 144) is produced by means of a method which comprises one or some of the features of the following embodiments directed to a method, and/or wherein the arrangement and/or the fuel cell device (100) and/or the flat member (125, 143, 144) is produced in a facility which comprises one or more of the features of the following embodiments directed to a facility.
24. A method for producing an arrangement and/or a fuel cell device (100) and/or a flat member (125, 143, 144), wherein the method comprises at least the following steps of:
   providing a plurality of flat components (125, 143, 144, 262);
   providing at least one flat component (125, 143, 144, 262) with at least one adjustment mark (212);
   arranging at least one further flat component (125, 143, 144, 262) in the arrangement direction (129, 158) on top of the flat component (125, 143, 144, 262) provided with at least one adjustment mark, wherein even after the arrangement of the at least one further flat component (125, 143, 144, 262), the at least one adjustment mark (212) of the at least one flat component (125, 143, 144, 262) provided therewith can be detected by a detection means (222), in particular an optical detection means, and/or wherein the at least one adjustment mark (212) is not concealed by the at least one further flat component (125, 143, 144, 262).
25. The method, in particular according to the preceding embodiment, for producing an arrangement and/or a fuel cell device (100) and/or a flat member (125, 143, 144), wherein the method comprises one or more steps for forming the arrangement and/or the fuel cell device (100) and/or the flat member (125, 143, 144) with one or some of the features of the preceding embodiments directed to an arrangement and/or to a fuel cell device (100) and/or to a flat member (125, 143, 144) and/or wherein the arrangement and/or the fuel cell device (100) and/or the flat member (125, 143, 144) is/are produced, at least in part, by means of a facility which comprises one or more of the features of the following embodiments directed to a facility.
26. The method according to any one of the preceding embodiments directed to a method, wherein at least one adjustment mark (212) of at least one flat component (125, 143, 144, 262) is formed by welding, in particular by laser welding.
27. The method according to any one of the preceding embodiments directed to a method, wherein the same tool is used to weld at least some of a plurality of elements, in particular at least some flat products (262), forming a flat member (125, 143, 144) together and to provide the at least one flat member (125, 1243, 144) with at least one adjustment mark (212), in particular by welding.
28. The method, in particular according to any one of the preceding embodiments directed to a method, for producing an arrangement and/or a fuel cell device (100) and/or a flat member (125, 143, 144), wherein the method comprises at least the following steps of:
   adjusting at least one further flat component (125, 143, 144, 262) relative to at least one flat component (125, 143, 144, 262) marked with at least one adjustment mark (212) with the aid of at least one detectable and/or non-concealed adjustment mark (212) of the marked flat component (125, 143, 144, 262), and arranging the at least one further flat component (125, 143, 144, 262), in particular in the adjusted position, on flat components (125, 143, 144, 262) that are already arranged on top of one another and in particular comprise the at least one flat component (125, 143, 144, 262) marked with at least one adjustment mark (212), and in particular at least one further flat component (125, 143, 144, 262), wherein the at least one further flat component (125, 143, 144, 262) is arranged on top of the at least one flat component (125, 143, 144, 262) marked with at least one adjustment mark (212).
29. The method according to any one of the preceding embodiments directed to a method, wherein the at least one further flat component (125, 143, 144, 262) is adjusted such that a functional region (172) of the at least one further flat component (125, 143, 144, 262) to be adjusted is adjusted relative to a functional region (172) of the at least one flat component (125, 143, 144, 262) provided with at least one adjustment mark (212).
30. The method according to the preceding embodiment, wherein, when adjusting the respective functional regions (172), corresponding protruding portions in the respective functional regions (172) are adjusted relative to one another.
31. The method according to any one of the preceding embodiments directed to a method, wherein, in order to adjust at least one further flat component (125, 143, 144, 262) to be arranged in the stacking direction (129), at least one adjustment mark (212) of at least one already arranged flat component (125, 143, 144, 262) is detected by at least one optical detection means, in particular a camera.
32. The method according to any one of the preceding embodiments directed to a method, wherein the method comprises the step of checking, at least for a flat component (125, 143, 144, 262) in which at least one adjustment mark (212) is detected, in particular optically, whether this at least one adjustment mark (212) is formed in a positioning region (216) provided for this at least one adjustment mark (212) so as to be accurately positioned within predetermined tolerance limits.
33. A facility for producing an arrangement and/or a fuel cell device (100) and/or a flat component (125, 143, 144), wherein the arrangement and/or the fuel cell device (100) and/or the flat member (125, 143, 144) has at least a plurality of flat components (125, 143, 144, 262) arranged on top of one another in an arrangement direction (129, 158), wherein the facility comprises at least one tool for providing at least one flat component (125, 143, 144, 262) with at least one adjustment mark (212) and at least one adjustment device, wherein the adjustment device is designed to adjust at least one further flat component (125, 143, 144, 262) relative to the flat component (125, 143, 144, 262) provided with the at least one adjustment mark (212), on which component at least one further flat component (125, 143, 144, 262) is already arranged, by means of the at least one adjustment mark (212).
34. The facility, in particular according to the preceding embodiment, for producing an arrangement and/or a fuel cell device (100) and/or a flat member (125, 143, 144) having one or at least some of the features of the preceding embodiments directed to an arrangement and/or to a fuel cell device (100) and/or to a flat member (125, 143, 144), and/or for producing an arrangement and/or a fuel cell device (100) and/or a flat member (125, 143, 144) by means of a method which has one or at least some of the features of the preceding embodiments directed to a method.
35. The facility according to any one of the preceding embodiments directed to a facility, wherein the adjustment device comprises at least one optical detection means for detecting the at least one adjustment mark (212) of the at least one flat component (125, 143, 144, 262).
36. The facility according to any one of the preceding embodiments directed to a facility, wherein at least one tool of the facility, in particular a welding device, is designed to provide at least one flat component (125, 143, 144, 262) with an adjustment mark (212) and to join at least some elements forming the at least one flat component (125, 143, 144, 262).

The following detailed description and the graphic representation of different variants of one embodiment relate to preferred features and, for example, advantages of the invention.

### BRIEF DESCRIPTION OF THE DRAWINGS

In the drawings:

FIG. 1 is a schematic view of an embodiment of a fuel cell device which comprises at least one fuel cell unit having a stack of a plurality of flat members;

FIG. 2 shows a plurality of flat members to be arranged on top of one another for the stack;

FIG. 3 is a plan view of a variant of a flat member;

FIG. 4 is an enlarged view of a detail of a flat member in the region of an adjustment mark;

FIG. 5 shows a stack of a plurality of flat members arranged on top of one another, wherein adjustment marks on a flat member are not concealed by a flat member arranged on top of said component and can be detected by a detection means;

FIG. 6 is a plan view of a flat member formed from a plurality of flat products, wherein alignment structures formed in a flat product are accessible;

FIG. 7 is a sectional view of a flat member formed from a plurality of flat products in the region of a functional region provided with structures;

FIG. 8 is a plan view of a variant of a flat member;

FIG. 9 is an enlarged view of a detail of the flat member according to FIG. 8 in the region of an alignment portion having accessible alignment structures and, for example, of control structures and, for example, with adjustment marks;

FIG. 10 is a view of a detail of flat products having alignment structures which are accessible through a recess in another flat product;

FIG. 11 is a view similar to FIG. 10 with a variant of the recess; and

FIG. 12 is a view of a detail of a facility having alignment elements for aligning and holding flat products.

### DETAILED DESCRIPTION OF THE INVENTION

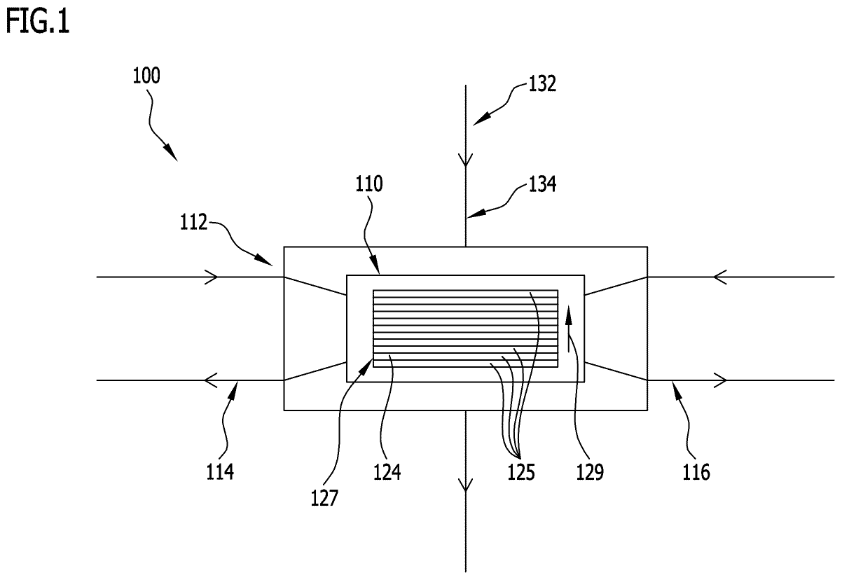

An embodiment of a fuel cell device designated as a whole by 100 comprises at least one fuel cell unit 110 and in particular a line system designated as a whole by 112 having at least one line apparatus 114 for a fuel medium and a line apparatus 116 for an oxidation medium, wherein the line apparatuses 114, 116 are connected to the at least one fuel cell unit 110 and partially formed therein, as schematically shown by way of example in FIG. 1.

The at least one fuel cell unit 110 comprises a plurality of cell units 124, wherein the fuel medium and the oxidation medium are at least partially chemically converted into a product medium in the cell units and in particular electrical energy is provided in the process.

In particular, the cell units 124 are connected in series.

The cell units 124 are formed from flat members 125 and the flat members 125 are arranged on top of one another in a stacking direction 129 in a stack 127.

By means of the line apparatus 114 for the fuel medium, the fuel medium can be supplied to an anode side of the fuel cell unit 110 and to respective anode sides of the individual cell units 124, in particular as a constituent of an anode fluid mixture, and a residual anode fluid mixture, which in particular comprises fuel medium portions and/or portions of the product medium and/or components of the supplied anode fluid mixture that are supplied to the at least one fuel cell unit 110 but not chemically converted therein, can be discharged again from the cell units 124 and from the at least one fuel cell unit 110.

By means of the line apparatus 116 for the oxidation medium, the oxidation medium, in particular as a constituent of a cathode fluid mixture, can be supplied to a cathode side of the at least one fuel cell unit 110 and to respective cathode sides of the individual cell units 124, and a residual cathode fluid mixture, which in particular comprises oxidation medium portions and/or portions of the product medium and/or portions of the supplied cathode fluid mixture that are supplied to the at least one fuel cell unit 110 but not chemically converted therein, can be discharged again from the cell units 124 and from the at least one fuel cell unit 110.

For example, a temperature-control apparatus 132 is also provided to keep the at least one fuel cell unit 110 within a temperature range permissible for proper operation thereof.

Preferably, the temperature-control apparatus 132 is designed for cooling and/or heating the at least one fuel cell unit 110 as required, in particular depending on an operating state of the fuel cell device.

In particular, the temperature-control apparatus 132 comprises, as part of the line system 112, a line apparatus 134 for a temperature-control medium for supplying a temperature-control medium to the fuel cell unit 110 and to the individual cell units 124 and for discharging the temperature-control medium from the individual cell units 124 and from the at least one fuel cell unit 110, wherein the temperature-control medium is in heat-exchanging contact with the fuel cell unit 110, in particular with the individual cell units 124, advantageously with the plurality of flat members 125, after being supplied and before being discharged.

In particular, the plurality of flat members 125 comprise flat components designed as bipolar plates 143 and in particular at least some flat members designed as membrane members 144.

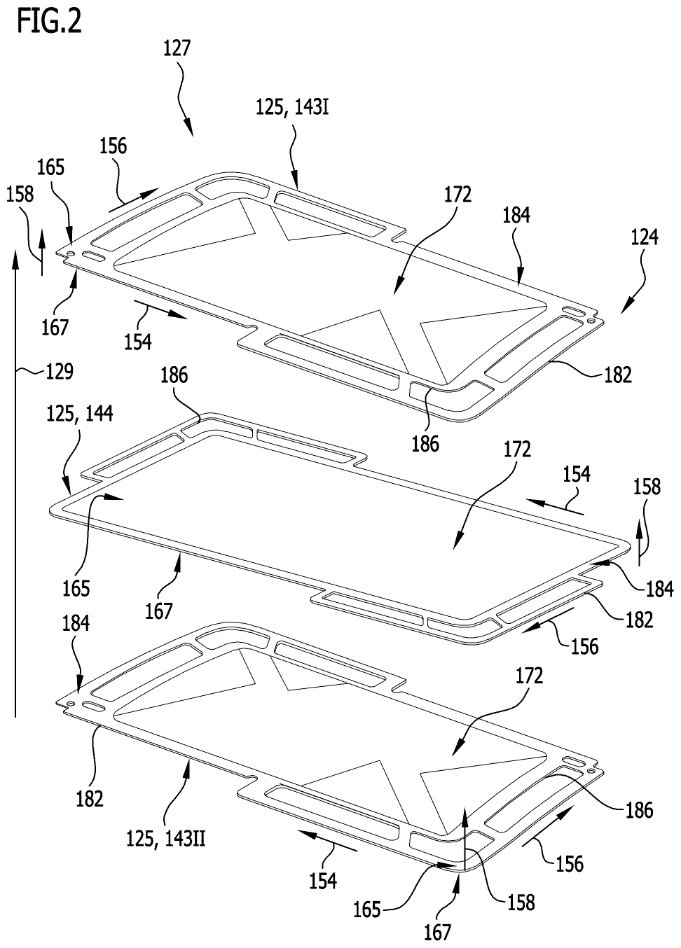

In particular, as shown by way of example in an exploded view in FIG. 2, a flat member designed as a membrane member 144 is arranged between each two flat components designed as bipolar plates 143, here for example between the two bipolar plates 143I and 143II, which collectively thus at least co-form a cell unit 124 in each case.

In particular, adjacent flat members 125, for example a bipolar plate 143 and a membrane member 144, are rigidly connected to one another, preferably so as to be fluid-tight, at least in portions.

Advantageously, a seal is formed at least between adjacent flat members 125, in particular between a bipolar plate 143 and a membrane member 144, which seal is, for example, over-molded and/or has a sealing cord and/or is applied by screen printing.

In particular, two bipolar plates 143 form at least one reaction chamber in each case, in which a membrane of a membrane member 144, which is arranged between the two bipolar plates 143, advantageously extends, wherein oxidation medium and fuel medium fed into the reaction chamber react chemically and electrical energy is provided during the chemical reaction.

Advantageously, the bipolar plates 143 are designed as an anode or cathode for a single cell unit 124.

In particular, the fuel medium is fed into a part of the reaction chamber delimited by the membrane of the membrane member 144 and by one of the two bipolar plates 143 and the oxidation medium is fed into a part of the reaction chamber delimited by the membrane of the membrane member 144 and the other of the two bipolar plates 143. The fuel medium and the oxidation medium interact via the membrane, in particular charged particles pass through the membrane from one part of the reaction chamber to the other part of the reaction chamber and particles of opposite charge pass via an electrical circuit from one part of the reaction chamber to the other part of the reaction chamber.

In particular, the surface of each of the flat members 125 extends in two areal extension directions 154 and 156 which are at least substantially perpendicular to one another and which span a geometric areal extension plane in each case.

Typically, the areal extension planes of the plurality of flat members 125 when stacked on top of one another in the stack 127 run at least substantially in parallel with one another and at least substantially perpendicularly to the stacking direction 129.

In particular, an extension of a flat member 125 in its vertical direction 158, which runs substantially perpendicularly to the areal extension directions 154 and 156, is considerably smaller, in particular at least 10 times smaller, for example at least 100 times smaller, than the extension of the flat member 125 in its areal extension directions 154, 156, wherein in particular the vertical extension direction 158 runs at least substantially in parallel with the stacking direction 129 when the flat members 125 are stacked in the stack 127.

The flat members 125 each have outer sides 165 and 167 that are opposite one another in their vertical direction 158 and the area of which extends in the areal extension directions 154 and 156.

For example, the outer sides 165, 167 comprise structuring of different heights in the vertical direction 158, as will be explained in more detail below.

In particular, in the stack 127, flat members 125 stacked directly on top of one another rest at least partially on one another with their outer sides 165, 167 facing one another.

In particular, in some flat members, which are advantageously designed as a bipolar plate 143, one of their outer sides 165, 167 is assigned to one of two adjacent cell units 124 in each case.

For example, some flat members 125, in particular designed as membrane members 144, are arranged in a cell unit 124.

At least some, preferably at least most, of the plurality of flat members 125 each have a functional region 172 in which in particular functional structure parts are arranged, wherein the one or more functional structure parts in each functional region 172 serve to fulfill at least one function of each flat member 125.

For example, the flat members designed as membrane members 144 have at least one membrane in their functional region 172, in particular for dividing at least one reaction chamber.

Advantageously, the flat members 125 designed as bipolar plates 143 have, in particular, vertically profiled fluid-carrying structures as functional structure parts, which are designed, for example, as channel structures, at least in part. In particular, at least some fluid-carrying structures at least partially form the reaction chamber. In particular, at least some fluid-carrying structures at least partially form line portions for a fluid.

In particular, at least some of the fluid-carrying structures are part of the line apparatus 114 for the fuel medium and/or the line apparatus 116 for the oxidation medium. In particular, some of the line portions are designed to supply the anode fluid mixture or the cathode fluid mixture to at least one reaction chamber and some line portions are designed to discharge the residual anode fluid mixture or the residual cathode fluid mixture from at least one reaction chamber.

For example, at least some of the fluid-carrying structures are part of the line apparatus 134 and carry the temperature-control medium in particular so as to provide heat-exchanging contact in the region of the functional region 172.

Advantageously, the fluid-carrying structures traverse at least a large part of the functional region 172 of a flat member 125 and, for example, at least parts of the fluid-carrying structures 174 have branched structures.

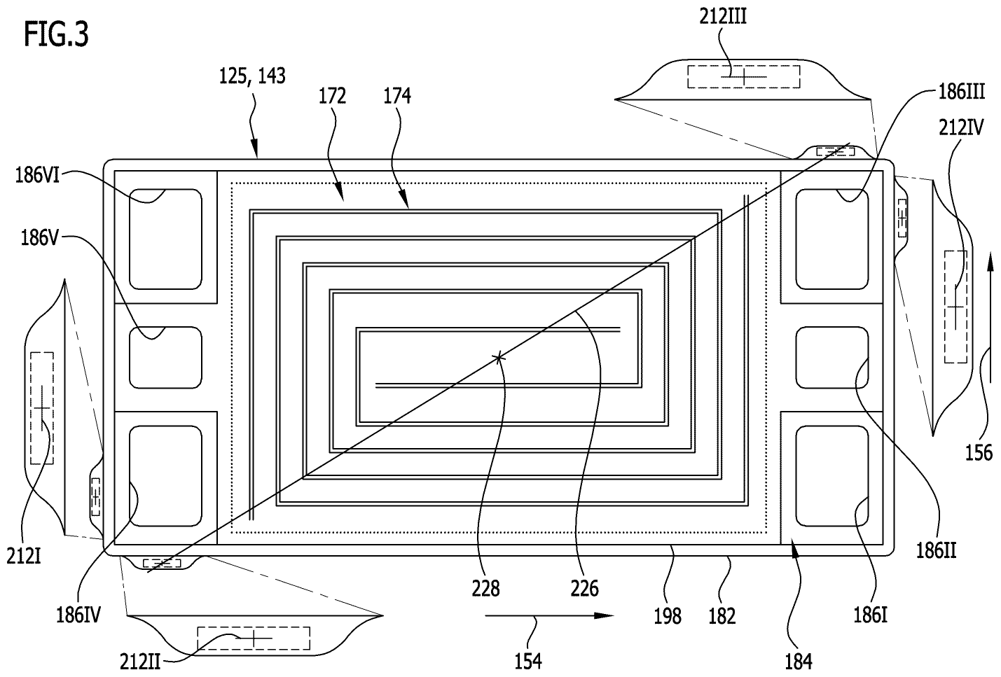

In particular, the fluid-carrying structures have a complex design and are shown in the drawings, for example in FIG. 3, only in a simplified schematic manner.

In particular, some flat members, in particular those designed as bipolar plates 143, have electrical functional structure parts in their functional region 172, in particular for forming the electrode, i.e., in particular depending on the side of the bipolar plate intended to form the anode or cathode, and/or for electrical connection to an electrode of an adjacent cell unit 124.

The flat members 125, 143, 144 have an edge 182 up to which the flat member 125, 143, 144 extends in its areal extension plane, and wherein the edge extends so as to be closed on the circumferential side.

In addition, the flat members 125, 143, 144 have an edge region 184 which extends inward from the edge 182, and wherein the edge region 184 advantageously surrounds the functional region 172 so as to be closed on the circumferential side.

In particular, as shown by way of example in FIGS. 2 and 3, a plurality of openings 186 are formed in the edge region 184 for other components to pass through.

For example, at least four, preferably six openings 186I to 186VI are formed, in each of which a distributor structure for supplying and discharging the corresponding medium is arranged as part of the line apparatuses 114, 116 for the fuel medium and the oxidation medium and, for example, of the line apparatus 134 of the temperature-control apparatus, wherein the distributor structure is often also referred to as a manifold.

In particular, at least two adjacent flat members 125 are rigidly connected to one another in their edge regions 184, in particular welded.

Preferably, at least one weld seam 198, in particular comprising a plurality of portions, runs in the edge region 184, by means of which at least two flat members 125, 143, 144 lying on top of one another are rigidly connected, for example, in a fluid-tight manner.

In particular, some portions of the weld seam 198 are designed such that at least part of the weld seam runs around the functional region 172 so as to be closed on the circumferential side.

Preferably, some portions of the weld seam 198 are designed such that openings 186, here for example the openings 186I, 186III, 186IV and 186VI, are each surrounded by part of the weld seam 198 so as to be closed on the circumferential side, and at least some openings 186 are separated from the edge 182, further openings 186 and the functional region 172 by portions of the weld seam 198.

Advantageously, in at least some flat members 125, here in particular in the flat components designed as bipolar plates 143, line portions are designed in particular with so-called gas ports, which run between a region with an opening 186 that is encircled by part of the weld seam 198 in a closed manner, in which opening a distribution structure for a medium is arranged, and the functional region 172 in order to connect these regions in a defined manner so as to carry fluid and to allow for a corresponding medium to be supplied or discharged.

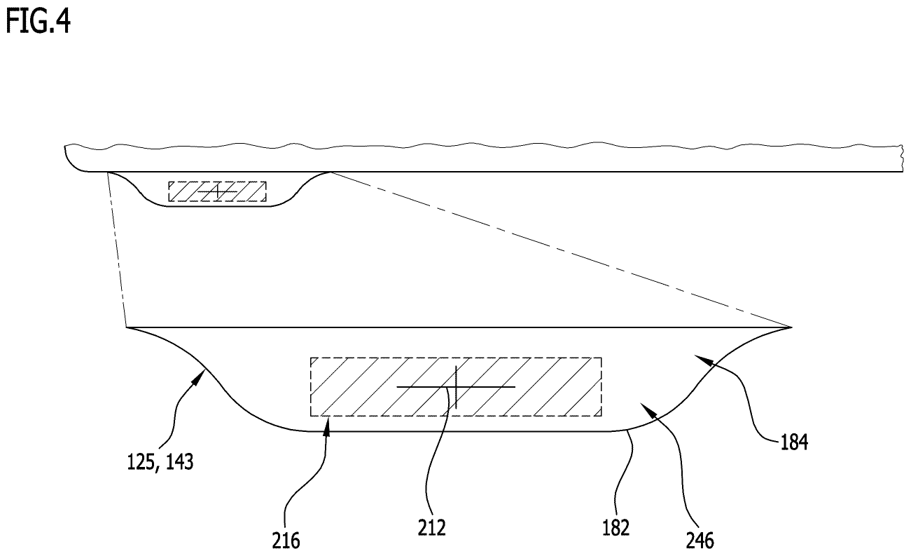

In particular, at least some of the plurality of flat members 125, advantageously at least some, in particular at least most, of the flat members 125 designed as bipolar plates 143, have an adjustment mark 212 or a plurality of adjustment marks 212, for example adjustment marks 212I, 212II, 212III, 212IV, as shown by way of example in FIGS. 3 and 4.

In particular, the plurality of adjustment marks 212 are fundamentally identical and the reference to “the adjustment mark” is to be understood as referring to at least one adjustment mark, preferably at least some, for example at least most, of the plurality of adjustment marks 212 and a Roman numeral designating a specific adjustment mark is only appended to the reference numeral if a specific adjustment mark is to be referred to.

In particular, the adjustment mark 212 is provided for adjusting the marked flat member 125 during assembly of the fuel cell device 100 when arranging the flat members 125 on top of one another in the stacking direction 129 to form the stack 127.

Advantageously, the adjustment mark 212 is an optically high-contrast mark that can be easily detected by an optical detection means.

In particular, the adjustment mark 212 is at least substantially thickness-neutral, i.e., a thickness of the marked flat member 125 in its vertical direction 158 is at least substantially not influenced by the adjustment mark 212.

Advantageously, the adjustment mark is formed on a portion that is continuously formed with material over the surface and in particular is formed only close to the surface of the portion, for example on and/or at the surface of the portion and/or at most with a small penetration depth into the material of the portion starting from the surface.

It is particularly advantageous if the adjustment mark 212 is a pattern welded in, for example, by laser welding.

In particular, the welded-in pattern of the adjustment mark 212 is intended only for marking purposes and does not form a joint connection between different parts.

In some variants, at least one adjustment mark is formed as an aperture in the flat member.

Preferably, the adjustment mark 212 is formed in a predefined positioning region 216, as shown by way of example in FIG. 4.

Preferably, the adjustment mark 212 is formed in the edge region 184, wherein the positioning region 216 is preferably located adjacently to the edge 182.

The adjustment mark 212 or the plurality of adjustment marks 212 can assume a wide variety of designs which are advantageous for detection. In particular, the plurality of adjustment marks 212 differ in their design, for example their shape and/or pattern, so that they can be distinguished by a detection means.

For example, at least one adjustment mark 212 comprises a line pattern and/or crosses and/or circular structures. In advantageous variants, at least one adjustment mark 212 is not rotationally symmetrical such that not only its position but also its orientation in the geometric areal extension plane of the marked flat member 125 can be identified and detected.

If a plurality of adjustment marks 212 are provided, at least some of these adjustment marks 212 are arranged far apart from one another with respect to the geometric areal extension plane of the marked flat member 125, as is shown by way of example in FIG. 3 for the adjustment marks 2121 and 212II, and the adjustment marks 212III and 212IV arranged at a large distance therefrom.

For example, the functional region 172 is arranged between two adjustment marks 212 arranged far apart from one another and/or adjustment marks 212 arranged far apart from one another are formed on different, for example opposite, portions of the edge region 184.

For example, adjustment marks 212 arranged far apart are formed in diagonally opposite corner regions of the edge region 184.

Preferably, at least two adjustment marks 212 are arranged on a flat member 262 such that a connecting line 226, which connects the at least two adjustment marks 212, runs through the surface center of mass 228 of the flat member 125, 143, 144, as shown by way of example in FIG. 3.

Advantageously, the surface center of mass 228 of the flat member 125, 143, 144 is at least substantially equidistant from the at least two adjustment marks 212.

For example, the at least two adjustment marks 212 are arranged diagonally opposite one another and/or at a distance from one another.

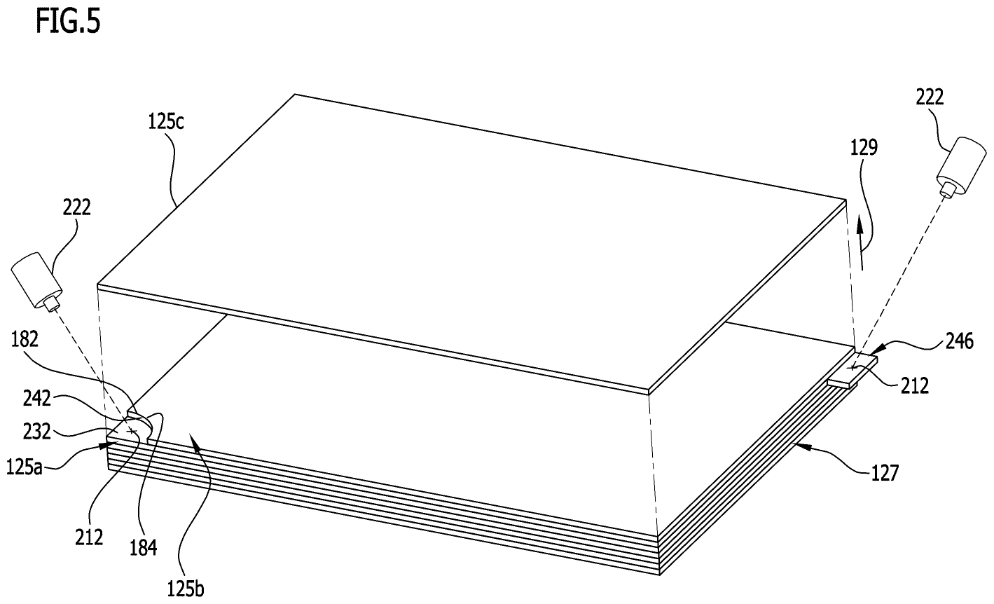

The adjustment mark 212 is preferably formed on an outer side, in particular on a surface portion 232 of the marked flat member 125, which faces the flat member 125 arranged next in the stack 127 in the stacking direction 129, as is shown by way of example in FIG. 5, for example, for the marked flat member 125a and the flat member 125b stacked next on top thereof.

In particular, the flat member which is the component stacked next on top of the marked flat member is designed as a membrane member 144, wherein the marked flat member is designed in particular as a bipolar plate 143.

Advantageously, the flat member which is the member stacked next on top of the marked flat member is formed free of material in the region lying above the adjustment mark 212 in the stacking direction 129.

In particular, the flat member 125 which is the member stacked next on top of the marked flat member 125 is formed free of material in a region of a projection of the adjustment mark 212 of the marked flat member 125 onto the geometric extension plane of the flat member 125 stacked next.

In some advantageous variants, the flat member 125 that is directly next in line for stacking has a recess 242 in the region above the adjustment mark 212 so that the adjustment mark 212 is not concealed and can be optically detected.

For example, in some variants, the recess 242 is formed in the flat member 125 in such a way that material portions run around the circumference thereof.

In advantageous variants, the recess 242 is formed as an indentation in the edge region 184, as shown by way of example in FIG. 5. In particular, the edge 182 of the flat member in the region of the recess 242 formed as an indentation is set back with respect to an outer contour of the stack 127 such that the adjustment mark 212 is not concealed.

For example, the recess 242 defines the predefined positioning region 216 for the adjustment mark 212 and/or the positioning region 216 is at least not concealed due to the recess.

In some favorable variants, the flat member 125 marked with the adjustment mark 212 has a marking portion 246 which protrudes beyond an outer contour of the stack 127 and which is provided with the adjustment mark 212 and in which in particular the predefined positioning region 216 is located, as shown by way of example in FIGS. 4 and 5.

For example, the marking portion 246 protrudes a few millimeters beyond the outer contour of the stack 127.

In particular, in the case of the recess 242 formed as an indentation and/or in the case of the protruding marking portion 246, a projection of the adjustment mark 212 and, for example, of the associated positioning region 216 onto the geometric extension plane of the flat member 125 stacked next is located in this geometric extension plane outside the extension of this flat member 125 stacked next, which extends up to the edge 182 thereof.

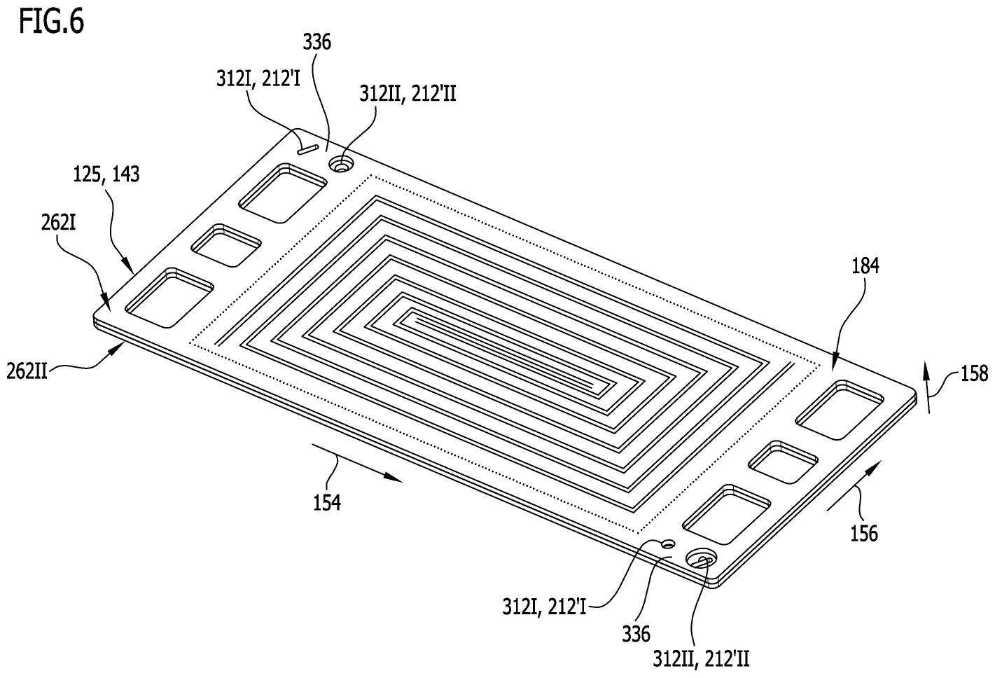

In particular, at least some flat members 125, advantageously at least most of the flat members 125 designed as bipolar plates 143, are substantially made of at least two flat products 262, in particular metal ones, as shown by way of example in FIG. 6 for a variant having two flat products 262I and 262II, wherein at least one further flat product co-forms a corresponding flat member 125 in variants.

In particular, the flat products 262 of a flat member 125 form layers thereof.

The flat products 262 of a flat member 125 are arranged one on top of the other in the vertical direction 158 which is substantially perpendicular to the geometric areal extension plane of the flat member 125.

Should the flat products 262 of a flat member 125 be at least substantially identical in terms of their basic function and/or design, they will be collectively described below with reference to “the flat product 262.”

For example, the flat product 262 is a metal sheet.

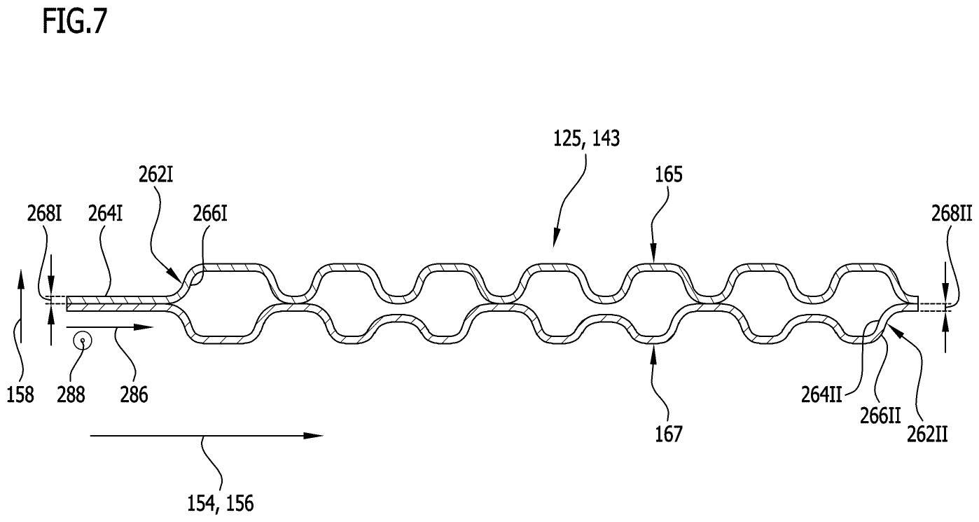

The flat product 262 has two opposite flat sides 264 and 266, which are spaced apart from one another by a thickness 168, as shown by way of example in FIG. 7.

In the case of flat members 125 made up of a plurality of flat products 262, outer flat sides 264, 266 of two outer flat products 262 form in each case the surfaces of the outer sides 165, 167 of the flat member 125 and inner flat sides 264, 266 face a flat side 264, 266 of a further flat product 262 so that, for example, the outer flat side 264I of the flat product 262I forms the outer side 165 and the flat side 266II of the flat product 262II forms the outer side 167 and the inner flat sides 266I and 264II of the flat products 262I and 262II are arranged opposite one another, as shown by way of example in FIG. 7.

In particular, in the case of a flat member designed as a bipolar plate 143, a flat product 262, which forms one of the outer sides 165, 167 of the flat component, forms an electrode for an associated cell unit 124 in each case.

In particular, the flat product 262 has a thickness 268 which is considerably smaller, in particular at least 10 times smaller, for example at least 100 times smaller, than extensions of the flat product 262 in directions of extension 286 and 288 which run at least substantially perpendicularly to one another and which at least locally run at least substantially perpendicularly to the thickness direction in which the thickness 168 is measured.

In particular, structures are formed in the flat products 262, which cause local differences in the height of the flat member 125.

Advantageously, in the functional region 172 of flat members, which are designed in particular as bipolar plates 143, at least some of the structures formed into a flat product form at least some fluid-carrying structures of the flat member.

Since structures rising from the areal extension plane, for example the fluid-carrying structures, are preferably formed in the flat product 262, the directions of extension 286 and 288 of the flat product 262 do not necessarily locally extend at least substantially in parallel with the areal extension plane, but for example the directions of extension 286 and 288 averaged over the extension of the flat member 125 in the areal extension directions 154 and 156 extend at least approximately in parallel with the areal extension plane.

An extension of the flat member 125 in the vertical direction 158 is greater than the sum of the thicknesses 268 of the flat product 262 forming the flat member 125 due to the structures emerging from the areal extension plane, such as the fluid-carrying structures, as shown by way of example in FIG. 7.

In some advantageous variants, at least one flat product 262, for example each of at least some flat products 262, of a flat member 125 formed from a plurality of flat products 262, for example a flat member formed as a bipolar plate 143 and/or as a membrane member 144, has at least one adjustment mark 212′ for adjusting the flat products 262 when arranging them on top of one another in the vertical direction 158.

Advantageously, at least one adjustment mark 212′, advantageously at least some adjustment marks 212′, of at least one flat product 262 and advantageously of at least some flat products 262 has/have at least one, and advantageously at least a combination, of the features explained above and/or below in connection with an adjustment mark 212 of a flat member 125, 143, 144.

It is particularly advantageous if at least two adjustment marks 212′ on a flat product 262 are arranged diagonally opposite and/or at a distance from one another, advantageously in order to be able to determine the alignment of the flat product 262 when the at least two adjustment marks 212′ are detected.

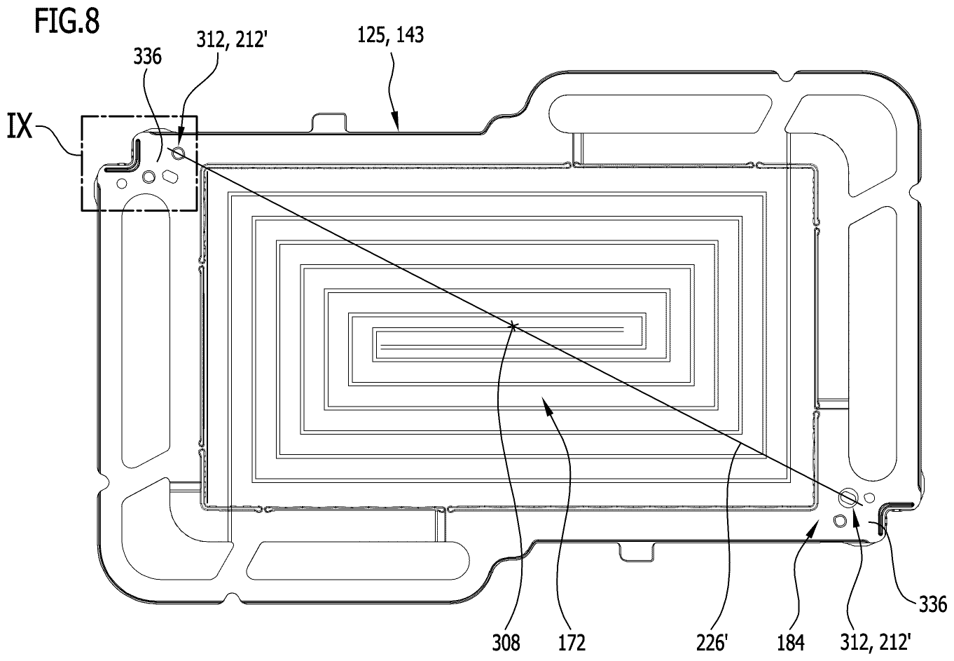

Preferably, at least two adjustment marks 212′ are arranged on a flat product 262 such that a connecting line 226′, which connects the at least two adjustment marks 212′, runs through the surface center of mass 308 of the flat product 262, as shown by way of example in FIG. 8.

Advantageously, the surface center of mass 308 of the flat product 262 is at least substantially equidistant from the at least two adjustment marks 212′.

In such a variant, the flat products 262 are advantageously adjusted and arranged on top of one another and in particular joined together in accordance with that explained in connection with the plurality of flat members 125, 143, 144.

In order to avoid repetition, reference is therefore accordingly made in full to the above statements with regard to such a variant, in particular with regard to advantageous embodiments of the at least one adjustment mark 212′ and the adjustment and arrangement processes.

As examples of variants, adjustment marks 212′ on flat products 262 are shown in FIGS. 6, 8 and 9. For example, the adjustment marks 212′, as described below in connection with the alignment structures 312, are formed as apertures.

For example, the adjustment marks 212′ are formed as above in connection with the flat members. Thus, at least FIG. 6, 8, 9 are also representative of these different variants of adjustment marks 212′ on flat products 262.

Preferably, at least one flat product 262, preferably each flat product 262, of a flat member 125 formed from a plurality of flat products 262, for example a flat member formed as a bipolar plate 143, has at least one alignment structure 312 which is accessible at least when said flat products are arranged on top of one another to form the flat member 125 and/or is released from the other flat product 262 or the other flat products of the plurality of flat products of the flat member 125.

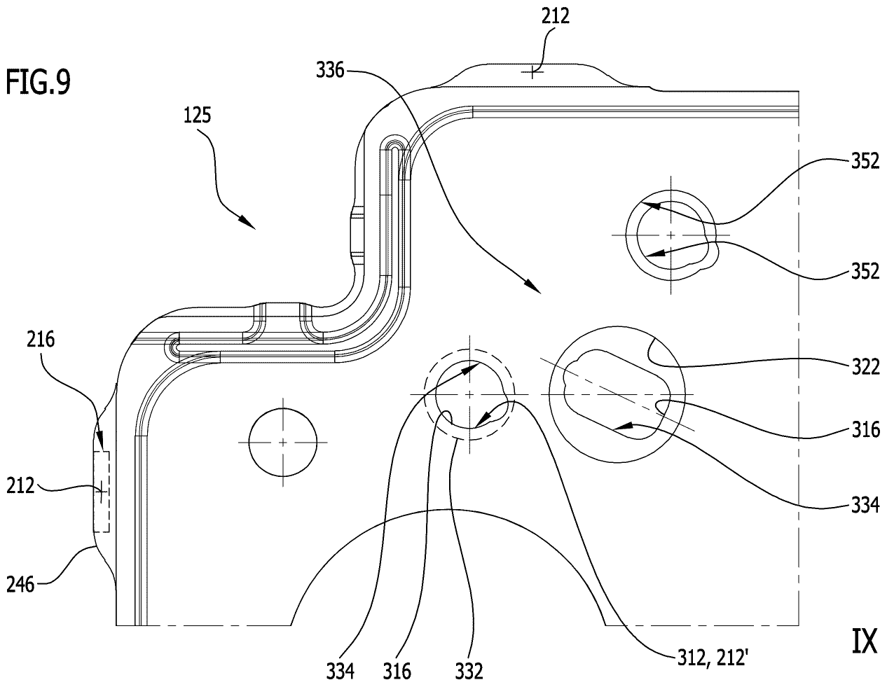

Plan views of a flat member 125 with alignment structures 312 in its flat products 262 are shown by way of example in FIGS. 6 and 8 and variants of designs of the alignment structures 312 are explained in connection with the example representations in FIGS. 9 to 11.

For example, in the case of the flat members 125 formed from the flat products 262I and 262II, each of the flat products 262I, 262II has an alignment structure 312I or 312II or preferably a plurality of, for example two, alignment structures 312I or 312II, wherein the alignment structures 312I, 312II are at least fundamentally identical and/or different features are interchangeable, unless explicitly explained otherwise below, so that the plurality of alignment structures 312I, 312II will be collectively explained below and reference is made only to the alignment structures 312.

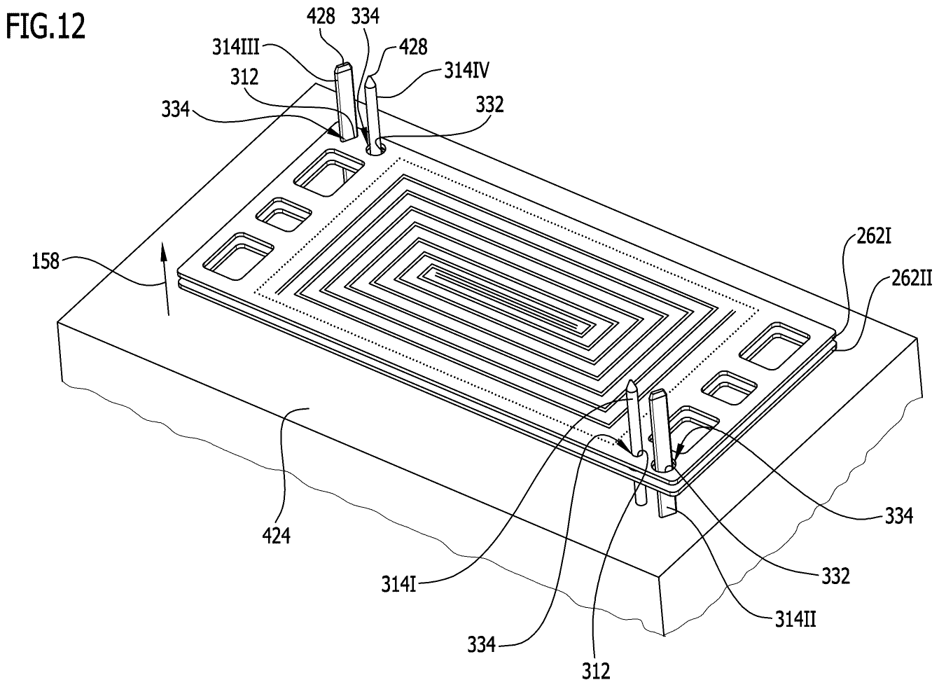

The alignment structure 312 is designed such that an alignment element 314 of a facility for producing the fuel cell device, in particular for producing the flat member 125, can engage with the alignment structure 312, in particular mechanically, for aligning and preferably holding the flat product 262, as shown for example in FIG. 12.

Preferably, the alignment structure 312 is formed as an aperture 316 which is continuous in the vertical direction 158 and extends between the two flat sides 264 and 266 of the flat product 262, as shown by way of example in FIGS. 9 to 11.

For example, the aperture 316 in at least one alignment structure 312 is at least substantially designed as a round hole and/or an elongated hole, wherein in this embodiment the alignment structures 312 of a flat product 262 preferably differ.

In particular, a plurality of alignment structures of a flat product 262 are designed such that when alignment elements 314 engage with the alignment structures 312, a location, in particular position and/or orientation, of the flat product 262 is not overdetermined.

For example, a flat product has an elongated hole and a round hole as alignment structures.

In particular, the alignment structure 312 is designed not to interact with the one other flat product 262 or the other flat products 262 of the flat member 125 so that the alignment structure 312 thus does not interact with any other flat product 262 of the flat member 125, in particular at least when aligning the flat product 262 provided with the alignment structure 312.

In particular, the alignment structure 312 is accessible and released in a release direction 322, which advantageously at least substantially corresponds to the vertical direction 158 of the flat member 125.

In particular, the further flat product 262 or the further flat products 262 of the flat member 125 are designed to be free of material in the projection of at least the alignment structure 312 and preferably also in the projection of a tolerance region 326 surrounding the alignment structure 312.

The tolerance region 326 surrounds the alignment structure 312, preferably so as to be inherently circumferentially closed.

In particular, the tolerance region 326 has an extension 328 starting from the alignment structure 312 and away therefrom in directions that run at least substantially perpendicularly to the release direction 322, i.e., in particular run at least substantially in parallel with the geometric extension plane, which extension corresponds to at least one tolerance that is permitted when aligning the flat product 262 provided with the alignment structure 312 relative to at least one further flat product 262, in particular relative to all the flat products 262, of the flat member 125.

In particular, the one other flat product 262 or the plurality of other flat products 262 of the flat member 125 have a recess 332 above or below the alignment structure 312 in the release direction 322, through which the alignment structure 312 is accessible and released in the release direction 322.

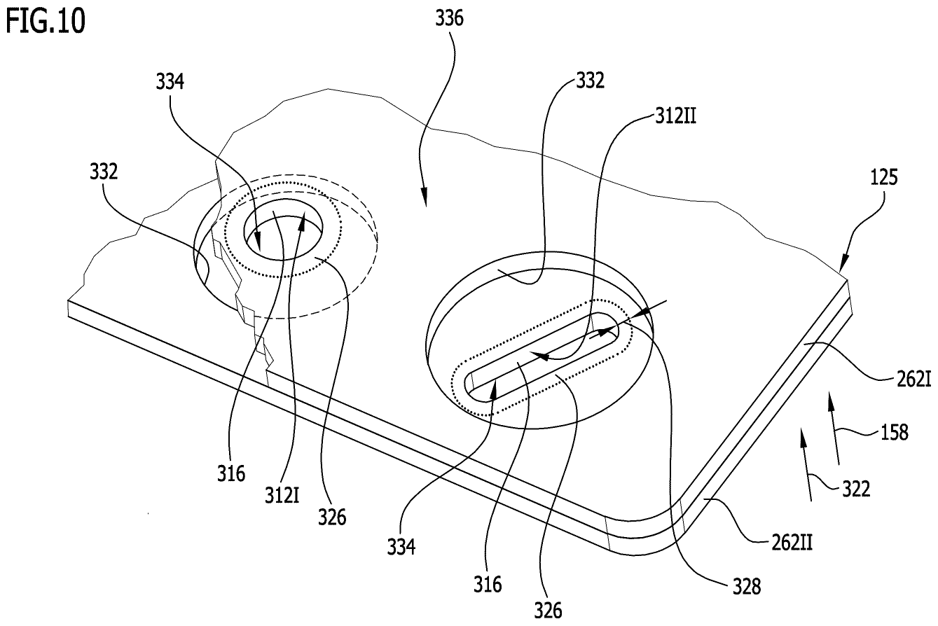

In some variants, the recess 332 is a recess within the extension of the other flat product 262 and this recess is circumferentially surrounded by the material of the flat product 262, as shown by way of example in FIG. 10 for two recesses 332.

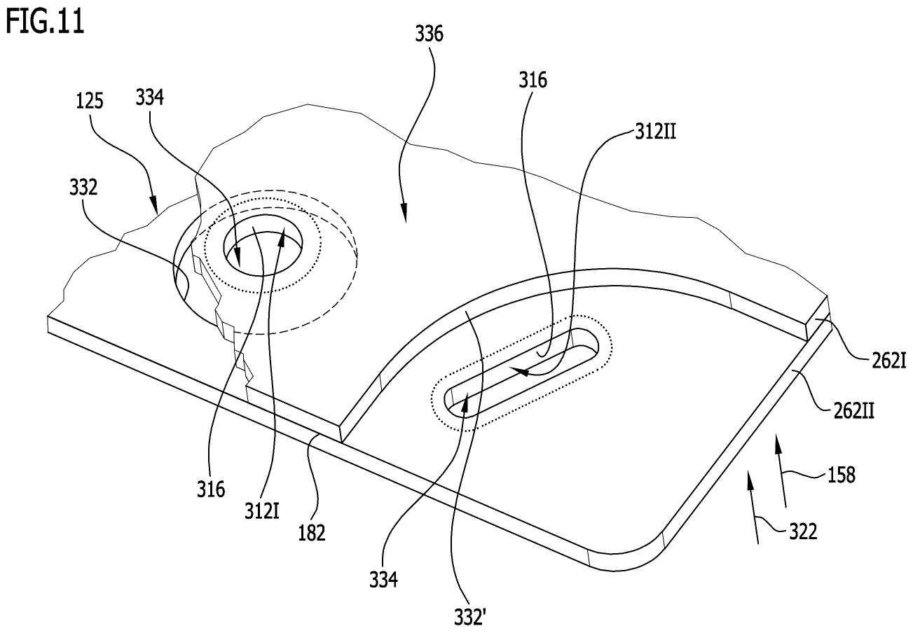

In some variants, the recess 332 is a recess at the edge of the flat product 262, which is formed, for example, as an indentation. In this case, in the region of this recess 332, the flat product 262 provided with this recess 332 does not extend as far as the flat product 262 having the corresponding alignment structure 312, for example it does not extend up to the edge 182 of the flat member 125. Rather, an edge of the flat product 262 with such a recess 332 is set back behind the alignment structure 312 and preferably behind the tolerance region 326 in the region of this recess 332. This is shown by way of example in FIG. 11 for a recess 332′, wherein the circumference of a further recess 332 shown is surrounded by the material of the corresponding flat product 262.

In particular, in the region of the alignment structure 312, a passage 334 is formed through the flat member 125, which runs continuously through the flat member 125 in the release direction 322 and opens up on the two outer sides 165, 167.

In this case, the passage 334 has its minimum extension in the flat product 262 provided with the alignment structure 312 in the region of the with the alignment structure 312, which is designed in particular as an aperture 316, at least substantially perpendicularly to the release direction 322, and is wider in the region of the other flat product 262 or the other flat products 262 at least approximately perpendicularly to the release direction 322 and in particular is provided with an extension which is at least the same size or greater than the extension of the alignment structure 312 plus the permissible tolerance, such that the alignment structure 312 and the tolerance region 162 surrounding it are accessible and released in particular on both sides.

Preferably, at least one flat product 262, for example all the flat products 262, of a flat member 125 has at least two alignment structures 312 arranged at a distance from one another, wherein in particular the functional region 172 is spatially located between the alignment structures 312 that are spaced far apart, in particular with respect to the areal extension directions 154, 156. In particular, the at least two alignment structures 312 spaced far apart are located at a distance from one another which corresponds to at least a minimum extension of the flat member 125 in its areal extension plane.

Preferably, at least one alignment structure 312 in at least two flat products 262, for example one alignment structure 312 in each of the plurality of flat products 262 of the flat member 125, are located close to one another in relation to the distance therebetween in a direction running substantially in parallel with the geometric areal extension plane, in particular these alignment structures are located in a locally limited alignment portion 336 of the flat member 125.

For example, an extension of an alignment portion 336 in the geometric areal extension plane is at most ten times as large, for example at most five times as large, as an extension of an alignment structure 312.

In particular, in an alignment portion 336 in at least one of the flat products 262, in particular in each of the plurality of flat products 262, an alignment structure 312 and a recess 332 for the alignment structure 312 in the other flat product 262 or for the alignment structures 312 in the other flat products 262 are formed.

For example, at least two alignment portions 336 are arranged far apart, wherein, for example, the functional region 172 is arranged between the alignment portions 312 arranged far apart, and/or the alignment portions 336 arranged far apart are spaced apart from one another by a distance which corresponds to at least a minimum extension of the flat member 125 in the geometric areal extension plane.

Preferably, at least one alignment structure 312, in particular at least some, for example all, of the alignment structures 312 are arranged in the edge region 184 of the flat member 125.

In particular, at least one alignment portion 336, in particular at least some, for example all, of the alignment portions 336 are arranged in the edge region 184.

It is particularly advantageous if at least the flat product 262 provided with the alignment structure 312 and at least one other flat product 262 each have a control pattern 352, by means of which correct positioning of the at least two flat products 262 relative to one another can advantageously be controlled.

For example, the control patterns 352 are patterns formed in each flat product 262.

In particular, the control patterns 352 are apertures formed in each of the flat products 262 and are advantageously arranged, for example, concentrically on top of one another in the vertical direction 158 when said flat products are aligned.

In FIG. 9, two control patterns 352 of two flat products 262 of the flat member 125, which are designed as substantially round holes, are shown by way of example, wherein in the correctly aligned state, the two round holes lie at least substantially concentrically on top of one another and thus the correct alignment of the two flat products relative to one another can be identified.

In particular, a method for producing a fuel cell device, in particular for producing a stack of flat members formed from flat products, comprises at least one or more of the steps explained below.

In particular, at least two flat products 262 are provided for producing a flat member 125 which in particular forms a bipolar plate 143.

Preferably, at least some of the flat products 262 are provided with at least one alignment structure 312.

In particular, at least some flat products 262 are provided with at least one alignment structure 312 by at least one punching process, in particular at least partially by shearing.

Shearing is advantageous because it allows the alignment structure 312 to be formed precisely.

In particular, it is provided that the alignment structure 312, in particular an aperture 316 therein, is formed largely, but for example not completely, by shearing and in a further step the material to be removed is finally and completely separated, whereby in the alignment structure 312, in particular the aperture 316, for example the round hole and/or elongated hole, a nose is formed in the structure created by the final separation process, for example by punching.

Preferably, the at least partial formation of at least some structures in the functional region 172, in particular fluid-carrying structures, in at least one surface product 262 takes place in a production step with the at least partial formation of at least one alignment structure 312, preferably by means of the same tool. In particular, the tool is a punching tool which imprints structures in the functional regions 172 and at least partially punches out the alignment structure 312, for example partially forming it by shearing.

In the other flat product 262 or the other flat products 262, for example, the recess 332 for releasing the alignment structure 312 in the at least one flat product 262 is formed by a simple and inexpensive but not precise separation process, for example by punching, since no precision is required for this material-free space.

For example, control patterns 352 are formed in at least some of the flat products 262.

Preferably, a control pattern 352 is at least largely formed by a precise method, for example by shearing, and in particular in a further step the material is finally separated, for example by punching, whereby a nose is formed in the control pattern, for example.

Advantageously, the other flat product 262 or the other flat products 262 is/are formed without material in the region of the alignment structure 312 and preferably of the tolerance region 326 surrounding this alignment structure 312, so that one flat product 262 provided with the alignment structure 312 can be aligned independently of the other flat product 262 or the other flat products 262, since the alignment element 314, which is adapted in particular in terms of its size to the alignment structure 312, does not engage therewith.

In particular, a recess 332, 332′ corresponding to the alignment structure 314 in the at least one flat product 262 is formed in the at least one other flat product 262, for example by punching.

An alignment element 314 of a facility for producing the flat component of the fuel cell device then engages with the corresponding alignment structure 312 of the flat product 262 and aligns this flat product 262, and the alignment elements 314 preferably hold the flat products 262 in the aligned position until the flat products 262 are joined together to form the flat member 125.

In particular, at least one alignment element 314 is provided at a machine station for assembling and producing the flat member 125, wherein at least one alignment element 314 is advantageously provided at this machine station for aligning and preferably for holding at least most of the flat products 262, for example all of the flat products 262.

By way of example, FIG. 12 shows a variant in which the alignment elements 314I and 314III are provided and designed for aligning and holding the flat product 262I and the alignment elements 314II and 314IV are provided and designed for aligning and holding the flat product 262II.

In this case, the at least one alignment element 314 provided and designed for aligning a corresponding flat product 262 is designed to cooperate, in particular mechanically, with an alignment structure 312 of the flat product 262 to be aligned for alignment purposes, in particular so as to fit perfectly therewith, and to at least substantially not interact with the other flat product 262 or the other flat products 262 of the flat member 125 to be produced, at least if this flat product 262 that is not to be aligned or the flat products 262 that are not to be aligned are at least roughly correctly arranged in the vertical direction 158 above or below the flat product 262 to be aligned in order to assemble the flat member 125, wherein a flat product 262 is at least roughly correctly arranged if its rough alignment already corresponds to the correct alignment, but deviations in the alignment beyond the permitted tolerance range, for example deviations beyond ten times the tolerance region, are still possible.

In particular, the alignment elements 314 are designed as rigid alignment elements 314. For example, the alignment elements 314 are pins extending in a longitudinal direction, wherein their longitudinal direction is oriented at least substantially in parallel with the vertical direction 158 of the flat member 125 to be produced.

Advantageously, the alignment elements 314, which are designed as pins, for example, extend away from a support 424 to an element end 428, wherein an alignment element 314 is preferably designed to taper in the region of its element end 428 toward its element end 428.

Advantageously, the particularly rigid alignment elements 314 are fixedly arranged relative to one another in an arrangement where they are precisely coordinated with one another so that a flat product 262 that interacts with the alignment elements 314 provided therefor is properly aligned by this interaction.

In the method, the station having the plurality of alignment elements 314 is loaded with the plurality of flat products 262, wherein at least some, in particular at least most, of the flat products 262 each come into engagement with at least one alignment element 314 by means of their at least one alignment structure 312 and are thereby aligned.

In particular, an alignment element 314, in particular designed as a pin, extends through the corresponding alignment structure 312 designed as an aperture 316, wherein the other flat product 262 or the other flat products 262 are designed to be free of material at least in the region of this alignment element 314 and in particular additionally in the region of a tolerance region 326 correspondingly surrounding this alignment element 314, and therefore they do not interact with this alignment element 314 and can be aligned independently thereof.

Advantageously, an alignment element 314 extends through a passage 334 formed by the plurality of flat products 262 and interacts only with the flat product 262 to be aligned, since the passage 334 has its smallest extension transversely to the vertical direction 158 and/or its narrowest region in the region of this flat product 262 to be aligned, and the alignment element 314 has a thickness transversely to its longitudinal extension which corresponds to, in particular fits perfectly with, this extension of the passage 334 in the region of the alignment structure 312 of the flat product to be aligned.

Preferably, the thickness of the alignment element 312 is at least substantially constant along its longitudinal extension, possibly except for a region at its element end 428.

Advantageously, a taper in the region of the element end 428 makes it easier to thread the flat product 262 to be aligned onto the alignment element 314.

Advantageously, the flat products 262 that are thus properly and in particular precisely aligned with one another are joined together, in particular welded together, wherein the flat products 262 are advantageously also held in the aligned position by the corresponding at least one alignment element 314 up to and during the joining process.

In particular, in the method, a stack 127 of flat members 125, in particular of bipolar plates 143 and membrane members 144, is produced by providing these flat members 125 and stacking them on top of one another and preferably joining them.

In particular, at least one flat member 125, preferably at least most of the bipolar plates 143, are provided with at least one adjustment mark 212, preferably in a predefined positioning region 216.

At least the flat member, which is in particular a membrane member 144, which is the component stacked next directly on top of the flat member provided with at least one adjustment mark 212, is formed free of material in the region of the at least one adjustment mark 212 so that at least when the two flat members 125 are roughly aligned with one another, the adjustment mark 212 can still be detected and/or is not concealed.

For example, a recess 332 is formed in the flat member 125 stacked next or the adjustment mark 212 is formed on a protruding portion.

The flat member 125 provided with an adjustment mark 212, for example the flat member 125a, is placed and mounted on top of the flat component arranged next, for example the flat component 125b, wherein the adjustment mark 212 is not concealed as a result of the design and arrangement of the flat members 125 and can still be detected by a detection means 222, in particular an optical detection means, as shown by way of example in FIG. 5.

When arranging a further flat member 125, for example the flat member 125c, the at least one adjustment mark 212 of the flat member 125 marked therewith, for example the flat member 125a, is still identifiable, even though at least one further flat member 125, for example the flat member 125b, is arranged on top of the marked flat member 125.

Advantageously, the at least one detectable adjustment mark 212 is detected by, for example, an optical detection means 222 and thus the actual position of the flat member 125 marked with this adjustment mark 212, here for example the flat member 125a, is detected and the further flat member 125, here for example the flat member 125c, is adjusted relative to the identifiable adjustment mark 212 and thus relative to the actual position of the flat member 125 marked with this adjustment mark 212, here for example the flat member 125a, and is stacked, in the state adjusted in this way, on top of the flat member 125, here for example on top of the flat member 125b, which is already arranged on top of the marked flat member 125.

Thus, the marked flat member 125, for example the flat member 125a, and the further flat member 125, for example the flat member 125c, are preferably precisely adjusted with one another in the stack 127, although at least one further flat member 125, for example the flat member 125b, is arranged between these flat members 125.

In particular, in the case of a flat member 125 formed from a plurality of flat products 262, the plurality of flat products 262 are joined and provided with at least one adjustment mark 212 in the same machine station, for example both by welding, preferably by the same welding device.

For example, the detection means 222, which is in particular an optical detection means, also detects the predefined positioning region 216 and detects whether the adjustment mark 212 is located within the predefined position range, thus providing a further step for controlling the proper production of the flat member 125.

For example, the detection means 222, which is in particular an optical detection means, identifies the positioning region 216 from its position relative to the edge 182 and/or from contours of the edge 182.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### LIST OF REFERENCE NUMERALS

100 fuel cell device
110 fuel cell unit
112 line system
114 line apparatus for fuel medium
116 line apparatus for oxidation medium
124 cell units
125 flat member (flat component)
127 stack
129 stacking direction (arrangement direction)
132 temperature-control apparatus
134 line apparatus of the temperature-control apparatus
143 bipolar plate
144 membrane member
154 areal extension direction
156 areal extension direction
158 vertical direction (arrangement direction)
165 outer side
167 outer side
172 functional region
182 edge
184 edge region
186 openings
198 weld seam
212 adjustment mark
216 positioning region
222 detection means
226 connecting line
228 surface center of mass of the flat member
232 surface portion
242 recess
246 mark portion
262 flat product (flat component)
264 flat side
266 flat side
268 thickness
286 direction of extension
288 direction of extension
308 surface center of mass of the flat product
312 alignment structure
314 alignment element
316 aperture
322 release direction
326 tolerance region
328 extension of the tolerance region
332 recess
334 passage
336 alignment portion
352 control pattern
424 support
428 element end

1. An arrangement of a plurality of flat components (125, 143, 144, 262) arranged on top of one another in an arrangement direction (129, 158) for a fuel cell device (100), wherein at least one flat component (125, 143, 144, 262) of the plurality of flat components (125, 143, 144, 262) has at least one adjustment mark (212), and the adjustment mark (212) can be detected by a detection means (222), in particular an optical detection means, even when at least one further flat component (125, 143, 144, 262) is arranged in the arrangement direction (129, 158) on top of the flat component (125, 143, 144, 262) marked with this adjustment mark (212).

2. The arrangement of a plurality of flat components (125, 143, 144, 262) arranged on top of one another in an arrangement direction (129, 158) for a fuel cell device (100) according to claim 1, wherein at least one flat component (125, 143, 144, 262) of the plurality of flat components (125, 143, 144, 262) has at least one adjustment mark (212), and the adjustment mark (212) is not concealed by a flat component (125, 143, 144, 262) which is the component arranged next in the arrangement direction (129, 158) on top of the flat component (125, 143, 144, 262) marked with this adjustment mark (212).

3. A fuel cell device (100) having the arrangement of a plurality of flat components according to claim 1, wherein at least some flat components (125, 143, 144, 262) are flat members (125, 143, 144) and the arrangement is a stack (127) of a plurality of flat members (125, 143, 144) of a fuel cell unit (110) stacked on top of one another in a stacking direction (129).

4. The arrangement of claim 1, further comprising a flat member (125, 143, 144) wherein at least some flat components (125, 143, 144, 262) are flat products (262) which at least co-form the flat member (125, 143, 144).

5. The arrangement of claim 1, wherein at least one adjustment mark (212) of at least one flat component (125, 143, 144, 262) is designed not to interact with at least the flat component (125, 143, 144, 262) arranged next.

6. The arrangement of claim 1, wherein at least one adjustment mark (212) of at least one flat component (125, 143, 144, 262) at least does not substantially increase and/or at least substantially reduce a thickness of the flat component (125, 143, 144, 262).

7. The arrangement of claim 1, wherein at least one adjustment mark (212) of at least one flat component (125, 143, 144, 262) is optically detectable and in particular is optically high-contrast.

8. The arrangement of claim 1, wherein at least one adjustment mark (212) of at least one flat component (125, 143, 144, 262) is formed on a portion of the flat component (125, 143, 144, 262) which is continuously formed with material.

9. The arrangement of claim 1, wherein at least one adjustment mark (212) of at least one flat component (125, 143, 144, 262) is formed on a surface portion (232) of the marked flat component (125, 143, 144, 262) which faces the flat component (125, 143, 144, 262) arranged next in the arrangement direction (129, 158).

10. The arrangement of claim 1, wherein at least one adjustment mark (212) of at least one flat component (125, 143, 144, 262) is formed only on a surface region of the flat component (125, 143, 144, 262) marked therewith.

11. The arrangement of claim 1, wherein at least one adjustment mark (212) of at least one flat component (125, 143, 144, 262) is a pattern that is welded into the at least one flat component (125, 143, 144, 262).

12. The arrangement of claim 1, wherein at least one adjustment mark (212) formed by welding is a welding pattern without a joint connection.

13. The arrangement of claim 1, wherein at least one adjustment mark (212) is designed as at least one depression, in particular as an aperture, in at least one flat component (125, 143, 144, 262).

14. The arrangement of claim 1, wherein at least one adjustment mark (212) of at least one flat component (125, 143, 144, 262) is designed to be rotationally asymmetrical such that the orientation of the marked flat component (125, 143, 144, 262) can be detected using this rotationally asymmetric adjustment mark (212).

15. The arrangement of claim 1, wherein at least one flat component (125, 143, 144, 262) has at least two adjustment marks (212) and in that a geometric connecting line (226) which connects the two adjustment marks (212) runs through the surface center of mass (228, 308) of the flat component (125, 143, 144, 262).

16. The arrangement of claim 1, wherein the surface center of mass (228, 308) of the flat component (125, 143, 144, 262) is at least substantially equally spaced apart from at least two adjustment marks (212).

17. The arrangement of claim 1, wherein at least one adjustment mark (212) of at least one flat component (125, 143, 144, 262) is formed in a predefined positioning region (216) which can be detected in particular by a detection means, in particular an optical detection means.

18. The arrangement of claim 1, wherein the flat component (125, 143, 144, 262) arranged next in the stacking direction (129) on top of the at least one flat component (125, 143, 144, 262) marked with at least one adjustment mark (212) is free of material in the region of the at least one adjustment mark (212) of the marked flat component (125, 143, 144, 262).

19. The arrangement of claim 1, wherein, in the case of the flat component (125, 143, 144, 262) which is the component arranged next in the stacking direction (129) on top of the at least one flat component (125, 143, 144, 262) marked with at least one adjustment mark (212), a region of at least one adjustment mark (212) of the at least one marked flat component (125, 143, 144, 262) lies outside an extension of the flat component (125, 143, 144, 262) arranged next.

20. The arrangement of claim 1, wherein at least some of the plurality of flat components (125, 143, 144, 262) each comprise a functional region (172) having different thicknesses and/or fluid-carrying structures and are each provided with at least one adjustment mark (212).

21. The arrangement of claim 1, wherein at least two flat members (125, 143, 144) at least co-form a cell unit (124) of the at least one fuel cell unit (110) in each case and in that, for at least some cell units (124), at least one of the flat members (125, 143, 144) co-forming the cell unit (124) in each case has at least one adjustment mark (212).

22. The arrangement of claim 1, wherein at least some, in particular at least most, of the flat members (125, 143, 144) in the at least one stack (127) which are designed as a bipolar plate (143) have at least one adjustment mark (212).

23. The arrangement of claim 1, wherein the arrangement and/or the fuel cell device (100) and/or the flat member (125, 143, 144) is produced by means of a method which comprises one or some of the features directed to the method, and/or in that the arrangement and/or the fuel cell device (100) and/or the flat member (125, 143, 144) is produced in a facility which comprises one or more of the features directed to a facility.

24. A method for producing an arrangement and/or a fuel cell device (100) and/or a flat member (125, 143, 144), wherein the method comprises at least the following steps of:
providing a plurality of flat components (125, 143, 144, 262);
providing at least one flat component (125, 143, 144, 262) with at least one adjustment mark (212);
arranging at least one further flat component (125, 143, 144, 262) in the arrangement direction (129, 158) on top of the flat component (125, 143, 144, 262) provided with at least one adjustment mark, wherein even after the arrangement of the at least one further flat component (125, 143, 144, 262), the at least one adjustment mark (212) of the at least one flat component (125, 143, 144, 262) provided therewith can be detected by a detection means (222), in particular an optical detection means, and/or wherein the at least one adjustment mark (212) is not concealed by the at least one further flat component (125, 143, 144, 262).

25. The method of claim 24, wherein the method comprises one or more steps for forming the arrangement and/or the fuel cell device (100) and/or the flat member (125, 143, 144) with one or some of the features directed to an arrangement and/or a fuel cell device (100) and/or a flat member (125, 143, 144) and/or wherein the arrangement and/or the fuel cell device (100) and/or the flat member (125, 143, 144) is/are produced, at least in part, by means of a facility which comprises one or more features directed to a facility.

26. The method of claim 24, wherein at least one adjustment mark (212) of at least one flat component (125, 143, 144, 262) is formed by welding, in particular by laser welding.

27. The method of claim 24, wherein the same tool is used to weld at least some of a plurality of elements, in particular at least some flat products (262), forming a flat member (125, 143, 144) together and to provide the at least one flat member (125, 1243, 144) with at least one adjustment mark (212), in particular by welding.

28. The method of claim 24, wherein the method comprises at least the following steps of:
adjusting at least one further flat component (125, 143, 144, 262) relative to at least one flat component (125, 143, 144, 262) marked with at least one adjustment mark (212) with the aid of at least one detectable and/or non-concealed adjustment mark (212) of the marked flat component (125, 143, 144, 262), and arranging the at least one further flat component (125, 143, 144, 262), in particular in the adjusted position, on flat components (125, 143, 144, 262) that are already arranged on top of one another and in particular comprise the at least one flat component (125, 143, 144, 262) marked with at least one adjustment mark (212), and in particular at least one further flat component (125, 143, 144, 262), wherein the at least one further flat component (125, 143, 144, 262) is arranged on top of the at least one flat component (125, 143, 144, 262) marked with at least one adjustment mark (212).

29. The method of claim 24, wherein the at least one further flat component (125, 143, 144, 262) is adjusted such that a functional region (172) of the at least one further flat component (125, 143, 144, 262) to be adjusted is adjusted relative to a functional region (172) of the at least one flat component (125, 143, 144, 262) provided with at least one adjustment mark (212).

30. The method of claim 24, wherein, when adjusting the respective functional regions (172), corresponding protruding portions in the respective functional regions (172) are adjusted relative to one another.

31. The method of claim 24, wherein, in order to adjust at least one further flat component (125, 143, 144, 262) to be arranged in the stacking direction (129), at least one adjustment mark (212) of at least one already arranged flat component (125, 143, 144, 262) is detected by at least one optical detection means, in particular a camera.

32. The method of claim 24, wherein the method comprises the step of checking, at least for a flat component (125, 143, 144, 262) in which at least one adjustment mark (212) is detected, in particular optically, whether this at least one adjustment mark (212) is formed in a positioning region (216) provided for this at least one adjustment mark (212) so as to be accurately positioned within predetermined tolerance limits.

33. A facility for producing an arrangement and/or a fuel cell device (100) and/or a flat component (125, 143, 144), wherein the arrangement and/or the fuel cell device (100) and/or the flat member (125, 143, 144) has at least a plurality of flat components (125, 143, 144, 262) arranged on top of one another in an arrangement direction (129, 158), wherein the facility comprises at least one tool for providing at least one flat component (125, 143, 144, 262) with at least one adjustment mark (212) and at least one adjustment device, wherein the adjustment device is designed to adjust at least one further flat component (125, 143, 144, 262) relative to the flat component (125, 143, 144, 262) provided with the at least one adjustment mark (212), on which component at least one further flat component (125, 143, 144, 262) is already arranged, by means of the at least one adjustment mark (212).

34. The facility of claim 33, wherein the adjustment device comprises at least one optical detection means for detecting the at least one adjustment mark (212) of the at least one flat component (125, 143, 144, 262).

35. The facility of claim 33, wherein at least one tool of the facility, in particular a welding device, is designed to provide at least one flat component (125, 143, 144, 262) with an adjustment mark (212) and to join at least some elements forming the at least one flat component (125, 143, 144, 262).
